(19) United States
(12) Patent Application Publication
(10) Pub. No.: US 2023/0196572 A1
(43) Pub. Date: Jun. 22, 2023

(54) METHOD AND SYSTEM FOR AN END-TO-END DEEP LEARNING BASED OPTICAL COHERENCE TOMOGRAPHY (OCT) MULTI RETINAL LAYER SEGMENTATION

(71) Applicant: Carl Zeiss Meditec, Inc., Dublin, CA (US)

(72) Inventors: Aditya Nair, Dublin, CA (US); Rogerio Guimaraes, Pasadena, CA (US); Homayoun Bagherinia, Oakwood, CA (US); Ali Salehi, Dublin, CA (US)

(73) Assignee: Carl Zeiss Meditec, Inc., Dublin, CA (US)

(21) Appl. No.: 18/086,016

(22) Filed: Dec. 21, 2022

Related U.S. Application Data
(60) Provisional application No. 63/292,194, filed on Dec. 21, 2021.

(51) Int. Cl. G06T 7/00

(52) U.S. Cl. CPC G06T 7/0012; G06T 2207/20084; G06T 2207/20081

(57) ABSTRACT

A System/Method/Device for automatic retinal layer segmentation from optical coherence tomography (OCT) implementing a deep learning machine model defined by any of multiple neural networks. The neural networks may use the feature of “attention”, and more specifically self-attention, such as by using transformers, to reduce the size of the OCT data and make the process more efficient. Additionally, new methods of data augmentation suitable for OCT data are presented.

### CROSS-REFERENCE TO RELATED APPLICATIONS

This application claims the benefit of priority under 35 U.S.C. 120 to U.S. Provisional Application Ser. No. 63/292,194 entitled “END TO END DEEP LEARNING BASED OCT MULTI RETINAL LAYER SEGMENTATION”, filed on Dec. 21, 2021, the entire contents of which are incorporated by reference for all purposes.

### FIELD OF INVENTION

The present invention is generally directed to retinal layer segmentation in OCT data. More specifically, it is directed to deep learning approaches to retinal layer segmentation and to the creation of augmented training samples.

### BACKGROUND

Optical coherence tomography (OCT) is a non-invasive imaging technique that uses light waves to penetrate tissue and produce image information at different depths within the tissue, such as an eye. Generally, an OCT system is an interferometric imaging system based on detecting the interference of a reference beam and backscattered light from a sample illuminated by an OCT beam. Each scattering profile in the depth direction (e.g., z-axis or axial direction) may be reconstructed individually into an axial scan, or A-scan. Cross-sectional slice images (e.g., two-dimensional (2D) bifurcating scans, or B-scans) and volume images (e.g., 3D cube scans, or C-scans or volume scans) may be built up from multiple A-scans acquired as the OCT beam is scanned/moved through a set of transverse (e.g., x-axis and/or y-axis) locations on the sample. When applied to the retina of an eye, OCT generally provides structural data that, for example, permits one to view, at least in part, distinctive tissue layers and vascular structures of the retina. OCT angiography (OCTA) expands the functionality of an OCT system to also identify (e.g., render in image format) the presence, or lack, of blood flow in retinal tissue. For example, OCTA may identify blood flow by identifying differences over time (e.g., contrast differences) in multiple OCT scans of the same retinal region, and designating differences in the scans that meet predefined criteria as blood flow.

An OCT system also permits construction of a planar (2D), frontal view (e.g., en face) image of a select portion of a tissue volume (e.g., a target tissue slab (sub-volume) or target tissue layer(s), such as the retina of an eye). Examples of other 2D representations (e.g., 2D maps) of ophthalmic data provided by an OCT system may include layer thickness maps and retinal curvature maps. For example, to generate layer thickness maps, an OCT system may combine en face images, 2D vasculature maps of the retina, with multilayer segmentation data. Thickness maps may be based, at least in part, on measured thickness difference between retinal layer boundaries. Vasculature maps and OCT en face images may be generated, for example, by projecting onto a 2D surface a sub-volume (e.g., tissue slab) defined between two selected layer-boundaries. The projection may use the sub-volume's mean, sum, percentile, or other data aggregation method between the selected two layer-boundaries. Thus, the creation of these 2D representations of a 3D volume (or sub-volume) data often relies on the effectiveness of automated (multi) retinal layer segmentation algorithm(s) to identify the retinal layers (or layer-boundaries) upon which the 2D representations are based/defined.

It is an object of the present invention to provide a practical deep learning solution to retinal layer segmentation of OCT data that outperforms traditional knowledge-based algorithms in terms of execution time.

It is another object of the present invention that the deep learning model be fast and accurate, and generalizes well to unseen data (data dissimilar to training input/output samples) with various pathological structures and is robust to high levels of noise.

It is a further object of the present invention to provide a deep learning model that generalizes well to scans from different instruments (e.g., CARL ZEISS's CIRRUS™ PLEXELITE™, and other OCT systems/instruments) and different scan patterns.

It is still another object of the present invention that the deep learning model require minimal effort to work on new scans with different signal and noise characteristics.

### SUMMARY OF INVENTION

The above objects are met in a method/system that provides a set of augmentation methods to generate a rich and diverse set of labeled data, uses a minimal and efficient network structure, provides proper pre-training and training procedures, and a loss function specific for the MLS problem.

An embodiment of the present invention provides a method and system for segmenting one or more target retinal layers from an optical coherence tomography (OCT) volume scan of an eye. The method/system may include acquiring the OCT volume scan (e.g., C-scan), such as by using an OCT system. Alternatively, the OCT volume scan may be acquired/collected form a data store of previously obtained OCT volume scans. Alternatively, the acquired OCT data may be a B-scan. The acquired OCT volume is then submitted, optionally in B-scan portions, to a deep learning machine model having a self-attention mechanism that differentially weighs the importance (or priorities) of different regions of each B-scan based on the regions' relationship to the one or more target retinal layers. This may be done by enhancing (e.g., weighing more heavily) regions of each B-scan associated with the one or more target retinal layers and deemphasizing (weighing less heavily) regions not associated with the target retinal layers. The deep learning machine model maintains the data density of the width dimension of each B-scan, but reduces the data density of the depth dimension of each B-scan based on the number of target retinal layers. In this manner, the amount of data of each B-scan along the axial direction that needs to be analyzed is reduced to only those portions pertinent to finding the one or more target retinal layers.

That is, each B-scan is made up of multiple adjacent A-scans, and the self-attention mechanism enhances one or more Layer-of-Interest (LOI) regions respectively associated with the one or more target retinal layers within each A-scan, for example, based on topology information. In this manner, all the adjacent A-scans of a B-scan can be processed in parallel without placing an excessive computing cost on the system. For example, if L is the number of target retinal layers to be segmented, then the present deep learning machine model may make L×W number of predictions per B-scan, with each of the L rows of predictions being of size 1×W and representing a Layer-of-Interest (LOI).

Each B-scan comprises a multiple adjacent A-scans. Optionally, the deep learning machine model is based on a neural network that includes a Linear Projection layer that converts the depth dimension of all A-scans (irrespective of their respective axial dimension size) to a common, fixed depth dimension smaller than their original depth dimension. For example, the depth dimension of each A-scan may be reduced at least by a factor of 100. In an embodiment of the present invention, the neural network includes a transformer encoder, and the converted A-scans are input to the transformer encoder. This transformer encoder may include multiple transformer layers. In embodiments, the output of the transformer encoder is projected to a prediction layer by a second Linear Projection layer, and the prediction layer provides segmentation information of the one or more target retinal layers to an output layer that outputs the predictions on a per A-scan basis in parallel.

Optionally, the output from the self-attention mechanism is processed to produce predictions of the segmentation of the one or more target retinal layers and associates confidence maps for each of the predicted segmentations of the one or more target retinal layers. Optionally, the predicted segmentations of the one or more target retinal layers are of the form of 2×(w), where w is the width of a submitted B-scan.

The prediction may include, per target retinal layer, a center prediction termed “center” and a heights prediction term “heights”, and the output upper layer boundary ymax and lower layer boundary ymin per segmented target retinal layer is defined as

$$y min = center - \frac{1}{2} * {h}_{1} {e}^{{h}_{2} * heights}$$

$$y max = center + \frac{1}{2} * {h}_{1} {e}^{{h}_{2} * heights}$$

where h₁ and h₂ are hyperparameters defining the thickness prediction of the target retinal. Here, h₁ and h₂ may be determined experimentally.

The above objects are also met in a method or system for segmenting one or more target retinal layers from an optical coherence tomography (OCT) scan of an eye that includes: acquiring the OCT scan (including at least one B-scan); and submitting the OCT volume scan in B-scan segments to a deep learning machine model based on a neural network whose training set includes augmented training samples. Creation of the augmented training samples may include: collecting raw spectral data with high-resolution using an OCT system; constructing primary high-resolution OCT image data from the collected raw spectral data with high-resolution; defining ground truth layer segmentation label data from the high resolution OCT scan; amending the raw spectral data and generating secondary OCT image data; and using the secondary OCT image as an augmented training input sample and the ground truth layer segmentation label data as part of a training output target sample in the training of the neural network.

In this approach, the primary high-resolution OCT image data and the secondary OCT image data provide structural data. Also, the acquired OCT scan may be a volume scan comprising a plurality of these B-scans.

The raw spectral data may be amended by degrading the raw spectral data. Alternatively, or in addition, the raw spectral data may be amended by applying local wrapping and changes in reflectivity to simulate at least one of a plurality of pathologies. Also, the raw spectral data may be amended by accessing sample noise data from a store of OCT noise scans and applying the sampled noise data to the raw spectral data.

Optionally, the ground truth layer segmentation label data may be defined by submitting the primary high-resolution OCT image data to an automated Multi retinal Layer Segmentation utility.

Other objects and attainments together with a fuller understanding of the invention will become apparent and appreciated by referring to the following description and claims taken in conjunction with the accompanying drawings.

Several publications may be cited or referred to herein to facilitate the understanding of the present invention. All publications cited or referred to herein, are hereby incorporated herein in their entirety by reference.

The embodiments disclosed herein are only examples, and the scope of this disclosure is not limited to them. Any embodiment feature mentioned in one claim category, e.g., system, can be claimed in another claim category, e.g., method, as well. The dependencies or references back in the attached claims are chosen for formal reasons only. However, any subject matter resulting from a deliberate reference back to any previous claims can be claimed as well, so that any combination of claims and the features thereof are disclosed and can be claimed regardless of the dependencies chosen in the attached claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

In the drawings wherein like reference symbols/characters refer to like parts:

FIG. 1 depicts an image of an example set of multiple retinal layers of related art.

FIG. 2 depicts a network's intermediate output shapes/dimensions/layers/blocks in accordance with various embodiments.

FIG. 3 is a block diagram of a transformer-based exemplary workflow in accordance with various embodiments.

FIGS. 4A and 4B provide some exemplary RNFL segmented images of an OCT image using different segmentation techniques for comparison, including output segmented RNFL images obtain in accordance with various embodiments.

FIG. 5 depicts a set of images for comparison of outputs of multi-layer segmentation obtained by a knowledge-based MLS algorithm (shown in solid white) and predicted retinal layer positions obtained in accordance with various embodiments.

FIG. 6 illustrates a diagram of a workflow for segmenting one or more target retinal layers from an optical coherence tomography (OCT) volume scan of an eye in accordance with various embodiments.

FIGS. 7A and 7B depicts a first and second sample images with the first image configured with ground-truth retinal layers (as labeled) and the second image configured with estimated/predicted retinal layers provided by a present initial machine model in accordance with various embodiments.

FIGS. 8A and 8B illustrate examples of some global time-domain data augmentation, including the original (B-scan) image, with labeled retinal layers, from which the data augmentation is based.

FIGS. 9A and 9B depicts a set of B-scan images including an original B-scan, and various data augmentation B-scans generated from the original B-scan by applying of a present set of local augmentations (e.g., local morphing) techniques in accordance with various embodiments.

FIG. 10 illustrates a diagram of an exemplary neural network that applies a convolutional process to an image in accordance with various embodiments.

FIG. 11 illustrates an example of a slit scanning ophthalmic system for imaging a fundus in accordance with various embodiments.

FIG. 12 illustrates a generalized frequency domain optical coherence tomography system used to collect 3D image data of the eye suitable for use in accordance with various embodiments.

FIG. 13 shows an exemplary OCT B-scan image of a normal retina of a human eye, and illustratively identifies various canonical retinal layers and boundaries in accordance with various embodiments.

FIG. 14 depicts an exemplary en face vasculature image in accordance with various embodiments.

FIG. 15 depicts an exemplary B-scan of a vasculature (OCTA) image in accordance with various embodiments.

FIG. 16 illustrates a diagram of an exemplary multilayer perceptron (MLP) neural network in accordance with various embodiments.

FIG. 17 illustrates a diagram of a simplified neural network consisting of an input layer, a hidden layer, and an output layer in accordance with various embodiments.

FIG. 18 illustrates an exemplary convolutional neural network (CNN) architecture in accordance with various embodiments.

FIG. 19 illustrates a diagram of an exemplary U-Net architecture in accordance with various embodiments.

FIG. 20 illustrates an exemplary computer system (or computing device or computer) in accordance with various embodiments.

### DESCRIPTION OF THE PREFERRED EMBODIMENTS

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not for limitation. Furthermore, any reference to singular includes plural embodiments, and any reference to more than one component or step may include a singular embodiment or step. Also, any reference to attached, fixed, connected, or the like may include permanent, removable, temporary, partial, full, or any other possible attachment option. Additionally, any reference to without contact (or similar phrases) may also include reduced contact or minimal contact. It should also be understood that unless specifically stated otherwise, references to “a,” “an” or “the” may include one or more than one, and that reference to an item in the singular may also include the item in the plural. Further, all ranges may include upper and lower values, and all ranges and ratio limits disclosed herein may be combined.

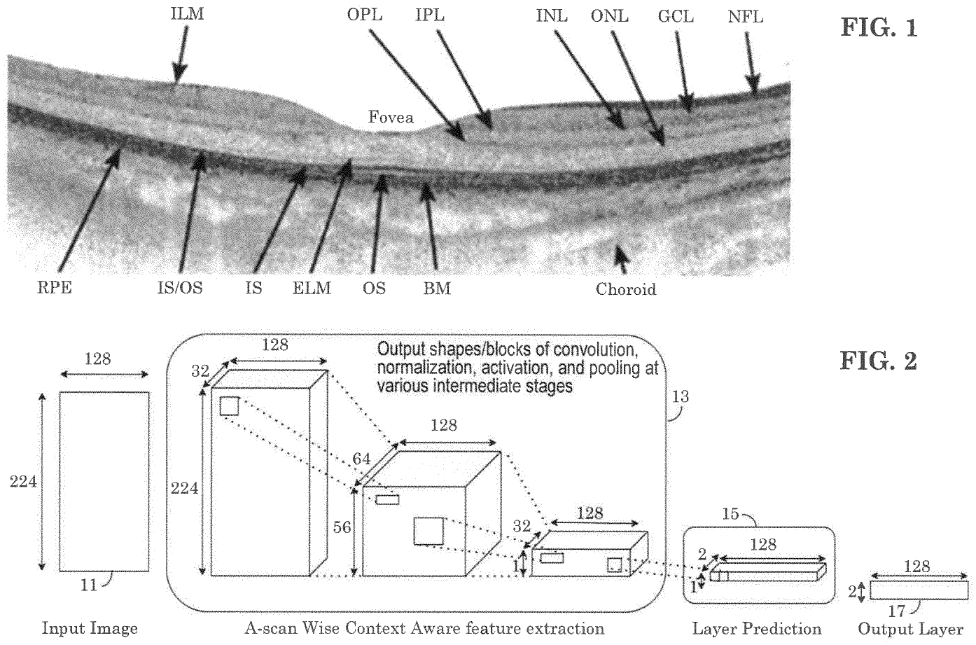

Analysis of the thickness of various retinal layers in an OCT image provides valuable clinical insight and is useful for monitoring eye health. Segmenting different layers, such as the Inner Limiting Membrane (ILM) or the Retinal Pigment Epithelium (RPE), in an OCT image not only has several clinical applications but also helps with algorithm development. An example of the fovea and some retinal layers is provided in FIG. 1. Exemplary retinal layers shown the Inner Limiting Membrane (ILM), Nerve Fiber Layer (NFL), Ganglion Cell Layer (GCL), Inner Plexiform Layer (IPL), Inner Nuclear Layer (INL), Outer Plexiform Layer (OPL), Outer Nuclear Layer (ONL), junction (IS/OS) between Outer Segments (OS) and Inner Segments (IS), Externa Limiting Membrane (ELM), Retinal Pigment Epithelium (RPE), the Bruch's Membrane (BM), and the choroid region. Another view of retinal layers is provided below.

Methods for extracting various retinal layer information (e.g., layer boundary or layer thickness information) from an OCT (e.g., structure) image (and creating a map of this information, e.g., thickness maps) rely on traditional knowledge-based algorithms or methods that semantically segment the OCT image/data using machine learning techniques. While knowledge-based algorithms can be efficient, they often require data-specific hand tuning which can make scaling these methods to accommodate new data types difficult, or impractical.

In addition to knowledge-based approaches, deep learning approaches have also been considered. Deep learning approaches, e.g., artificial intelligence (AI), are attractive since there exists the possibility that they may make use of data overlooked by more traditional knowledge-based approaches, have the potential of being easier to develop and/or train than knowledge-based approaches (if sufficient training data is available), and their resultant trained models can sometimes be faster than knowledge-based approaches. Previous attempts at using deep learning for retinal layer segmentation in OCT data, however, have faced various difficulties that have limited their practical implementation. For example, one difficulty is that deep learning models (e.g., based on neural networks) typically require a large library of training samples, and it is often expensive and impractical to collect such a large library of labeled training samples.

Nonetheless, the study, diagnosis, and monitoring of retinal disease benefits greatly from modeling anatomical structures in OCT images. (Automated) Multi retinal Layer Segmentation (MLS) utility/method/tool/application are crucial component and often an early step in such analysis pipelines. However, various retinal diseases make developing automated algorithms for this task challenging. Automated segmentation methods may be divided into two categories; knowledge-based (classical) and learning-based (e.g., deep learning) methods.

Knowledge-based (classical) algorithms have been developed to estimate the boundaries of several retinal layers from B-scan images. Those methods are usually based on some assumptions about the input images and anatomy, and comprise several hand-designed steps to extract useful features from input images. These are usually slow and may not work on a new set of data that does not satisfy the algorithm's assumptions. Extreme variations in morphology and alignment of layers due to retinal diseases could cause issues for this method. Compared to machine learning-based methods, the primary advantage of such methods is that they do not require human-labeled ground-truth data.

Machine learning methods, especially deep learning ones, have been shown to handle many limitations of classical models. These models are trained in a supervised fashion by providing B-scans or a set of B-scans as input and ground-truth segmentation masks/images (or boundaries) as training target data. The need for a diverse set of training data (e.g., to provide examples of different scan types, scanning systems, imaging artifacts, pathology examples, etc.) with accurate ground-truth (e.g., labels) limits the ability of such models. The generalizability of deep learning methods to unseen data is also an issue for poorly designed networks and limited training data.

Layer segmentation is generally addressed by one of two methods: (1) using a knowledge-based algorithm, which typically involves using a graph based set up to enforce prior knowledge about the layers; or (2) a hybrid deep learning based set up that involves using deep learning (e.g., a neural network) for making dense predictions (predicting for every pixel, as in semantic segmentation) and then using knowledge-based methods (e.g., in post-processing) to extract the layer(s) of interest from these images (e.g., the dense predictions output from the deep learning module).

The limitations of method (1) may include developing a new knowledge-based algorithm or modifying an existing algorithm (e.g., as when signal quality changes, such as due to a change in OCT device characteristics) requires more time and effort than simply retraining a deep-learning (neural network) model with new training data samples. Also, the accuracy of the predictions is not always informed by the general context of the image, and this lack of representational knowledge can make these methods less accurate.

A limitation of using a two-step approach, e.g., method (2), may include the runtime performance. The cost of making dense predictions (e.g., on a pixel-by-pixel basis) is much higher than predicting the layers in a deep learning approach, and the accuracy of the algorithm/model is also highly dependent on the hand-tuned, knowledge-based, post-processing method. These hand-tuned methods face similar drawbacks to those of method (1).

In various embodiments, attempts using deep learning to address obstacles in application of the retinal layer segmentation of OCT may include:
[1] Using convolutional neural network (CNNs) to create probability maps (images), and then using a graph-based approach to segment the layers from these images (e.g., probability maps). A discussion of CNNs is provided below.
[2] Addressing the segmentation problem in an end-to-end way, but making use of U-NETs to create an internal representation, and using pixelwise predictions to train this set-up. A general discussion of a U-net is provided. This approach would be much slower in deployment than directly regressing (e.g., predicting) the coordinates, as it is used in an embodiment of the present invention. The parameters of such a model would also be much larger than the present invention. Others have tried to use U-NETs in an end-to-end differentiable manner with SoftMax function towards the end to directly predict the layer positions. The SoftMax function, or more generally, a normalized exponential function, is a mathematical function that converts a vector of numbers into a vector of probabilities, where the probabilities of each value are proportional to the relative scale of each value in the vector. The SoftMax function is typically used as the last activation function of a neural network to normalize the output of a network to a probability distribution over predicted output classes, such as described in Luce's choice axiom known from probability theory. These methods also create an internal dense representation similar to a U-NET. Hence, these methods are less accurate and much more computationally expensive.
[3] Use of a fully connected layer neural network (NN), but this approach increases the number of parameters and does not capture the representation of “attention,” as used in the present invention. A discussion of fully connected layer NNs is provided below. Within the context of neural networks, “attention” is generally a technique that mimics cognitive attention. The effect enhances the important parts/regions of input data and fades out the rest (e.g., enhances (e.g., weighs more heavily) regions of an input image associated with a target layer and deemphasizes (e.g., weigh less heavily or weigh close to (or weigh to) zero regions not associated with the target layer). The neural network should devote more computing power to that small but important part/region of the input data (e.g., that is likely to include the target layer).
[4] Previous attempts at using “attention” for segmentation have proven to be expensive, and unlike the present invention, they do not take advantage of the internal structure of the input data.

A challenge of retinal layer segmentation (or other retina layer analysis) of OCT data/images using a data centric/deep learning-based technique revolves arounds posing the problem as a multi-stage set up. These stages typically involve segmenting the layers of the OCT image in a semantic or dense prediction manner and later applying several post processing methods to extract the region of interest (ROI) using hand tuned knowledge-based algorithms.

If this process were wrapped in an end-to-end, deep learning-based method, it would imply:
learning directly from data and making better quality predictions than tuning some results by hand;
using less code and manual tuning, which is not only time consuming but also requires much code maintenance;
a faster pipeline; instead of making dense predictions (e.g., for each pixel) and later extracting layer information, the predictions (e.g., of the boundary layers) are directly in the layer format (e.g., embedded within the layer information).

The present invention addresses several difficulties associated with a deep learning approach to retinal layer analysis. Some problems/objectives that the present invention addresses include:
Taking as input an OCT image (e.g., a slice, or B-scan, of an OCT volume) or multiple OCT images and predicting the “Layers-of-Interest” (LOI) directly from the images (OCT data) (e.g., determining the one or more layer whose boundaries are to be identified/determined and applying “attention” on this layer(s) based on the internal structure of the data, e.g., based on topology information in the data);
Making the set-up end-to-end, deep learning-based, and fully differentiable to directly learn from the data;
Solving theses problem in an efficient, fast, and accurate manner;
Learning in a semi-supervised manner (e.g., learning from (e.g., making use of at least some) knowledge-based algorithms to produce ground truth samples (e.g., images whose layer boundaries are labeled by one or more knowledge-based algorithm) for training and avoid, or reduce, extensive manual labelling of images);
In training, giving a lower weight to ground truth data (e.g., training data) that is of low confidence. The confidence associated with each layer point is preferably provided by the knowledge-based algorithm (for multi-retinal layer segmentation (MLS)). Alternatively, the present deep learning-based algorithm can also be designed/trained to output a similar confidence map (e.g., a confidence map used to appropriately weigh the training samples).

In this present embodiment, the layer segmentation problem is posed as a regression problem. A key feature of the present approach is that for an image of size H×W, the present embodiments make L×W number of predictions per image, where each row prediction of size 1×W represents a layer of interest and there are L such layers.

Two main end-to-end methods of solving this problem are put forth:

1: Layer Detection: The layer segmentation problem is posed as an object localization problem. The network architecture employed is modified to never lose resolution over the image width while aggregating features over the (image) height (axial) dimension. This architecture is made to be fully convolutional. After extracting these A-scan-wise features, another convolutional layer is used for making the layer predictions (e.g., extraction layer boundary information). The predictions of this network are assumed be of the form: (center location, log (layer thickness)). Optionally, exponential notation is used for layer thickness prediction. Finally, the top and bottom boundary layers are calculated using these predicted coordinates.
2: Transformers: A second architecture draws inspiration from the use of transformers in neural networks, which have shown state of the art performance in natural language processing (NLP) applications. Generally, a transformer is a deep learning model that adopts the mechanism of self-attention, differentially weighting the significance of each part of the input data. More specifically, the present invention takes inspiration from Bidirectional Encoder Representations from Transformers (BERT) architectures, as described, for example, in “Bert: Pre-training of deep bidirectional transformers for language understanding” by in Devlin, Jacob, et al., arXiv preprint arXiv:1810.04805 (2018), herein incorporated in its entirety by reference. The present invention, however, reposes the problem to manage the computation complexity of OCT data/image tasks.

The final attention outputs are used to regress (e.g., predict) the output layers and the confidence maps (e.g., associate the output layers with confidence maps/values). The present neural network (or deep learning machine model) produces clinically acceptable outputs while remaining fast (e.g., faster than previously achieved) for real world deployment (e.g., having speeds suitable for practical applications in the field).

The present network is trained on data where the ground truth outputs are created from an automated MLS (multi-retinal layer segmentation) algorithm, and the MLS segmentation confidence metric is used to weigh the loss gradients generated for each A-scan. Hence making this whole set up semi-supervised. The present network is trained using this MLS confidence weighted L1 loss (e.g., loss function) for the layer positions and a Binary Cross Entropy loss for the confidence metric.

Some advantages of the present end-to-end, Layer Detection network are:
Since it has fewer parameters than most previous networks used for retinal layer segmentation, it also requires a lower amount of data to learn to predict the retinal layer boundaries;
The network models the problem so it captures topology inherently into the model, preventing overfitting to certain layers;
The predictions are dense only in the image width dimension and can be trained to suit any resolution;
One can easily enforce any expected layer properties in OCT data, e.g., one layer position per A-scan (e.g., locate the position of a specific, targeted layer), layers may not cross each other, etc.

Some advantages of the present transformer-based network are:
It provides an (complete) end-to-end framework to train retinal layer segmentation algorithms;
It provides an efficient model, and can run quickly, even in CPU-based environments (e.g., does not require a high-end, general purpose graphics processing unit (GPGPU) environment);
The accuracy of the network is as good if not better than the current algorithms;
Since the predictions of this network is dense only in the image-width dimension, it can be trained to suit any resolution with little difficulty;
The internal representations of this network inherently capture the expected layer properties mentioned in the Layer Detection approach (incorporates the benefits/features in Item 1: Layer Detection, above.

The present problem of retinal layer detection is solved by using a custom architecture for this problem. The architecture consists of feature extraction and layer regression/prediction halves/parts. Five features of the present invention are:

1. The feature extraction half of a neural network in accordance with the present invention may consist of seven blocks/layers, including:
2D Convolution Layer
Batch Normalization Layer
Activation Layer
Max Pooling Layer
   Where all the convolutional layers have a filter shape/dimension of (3,3) (or 3×3) except the first block/layer which has a filter shape of (5,5) and they all have the “same” padding to retain the image shape. The number of channels in the convolutional layers start from 32 and go up to 64 on the third block and go back down to 32 in the seventh block. The Max pooling layers all have a stride of (2,1), thereby only reducing the features across the image height dimension (e.g., the direction in which one wants to predict the layer boundary position).
   2. The Layer Regression block consists of:
2D Convolutional Layer (3×3) filter size and 2 filters in depth;
average pooling layer to collapse the image dimension;
sigmoid activation layer to output in 0-1 range;
the outputs are then converted to ymin, ymax format using the equations below.

A depiction of the network intermediate output shapes/blocks/layers is shown in FIG. 2. The input image 11 (e.g., an OCT B-scan) in the present example is 224×128 (e.g., the width is 128 A-scans wide, and the depth of each A-scan is 224 pixels (or image data pieces/segments/sections) deep along the axial direction). In the following shapes/blocks/layers, the width dimension is preserved, but the depth dimension is reduced to only 2, preferable identifying a (e.g., targeted) retinal layer of interest. The 2 depth dimension identifies a layer of interest in a A-scan. It is to be understood that targeting (e.g., selecting) multiple layers could result in the depth dimension being adjusted or each of multiple layers may be identified separately, in parallel or sequentially). As shown, the 128 A-scans of the width dimension of input image 11 may be processed in parallel (e.g., each of the 128 A-scans that make up the input image may be processed in parallel). The central section 13 illustrates how the depth dimension is reduced by convolution, normalization, activation, and pooling at various intermediate stages. Block 15 provides a layer prediction, which may include topology information, and this is reduced to a 2×128 output layer block 17.

As shown, the predictions are of the shape/dimension of 2×(w), where w is the image width (e.g., number of A-scans in a B-scan or C-scan input image). If the 1^{st} dimension of this prediction is named as ‘center’ and 2^{nd} dimension is named as ‘heights’, then the output may be defined as:

$$y min = center - \frac{1}{2} * {h}_{1} {e}^{{h}_{2} * heights}$$

$$y max = center + \frac{1}{2} * {h}_{1} {e}^{{h}_{2} * heights}$$

Where h₁ and h₂ are hyperparameters influencing the thickness/height prediction of the network. These parameters may be determined experimentally. For the present work, h₁=10 and h₂=2.3. Parameters ymin and ymax may refer to the upper and lower boundary of the target layer(s), respectively.

The present implementation makes use of the 1D Dice coefficient (or Sørensen-Dice coefficient, or other known similarity coefficient, e.g., a statistic used to gauge the similarity of two samples). Finally, these outputs of the network are trained to maximize the 1D Dice coefficient to measure overlap of each predicted layer at every A-scan location, which can be stated as:

$$1 d Dice Coeffiencet = \frac{min \{ {y}_{p} max , {y}_{g} max \} - max \{ {y}_{p} min , {y}_{g} min \}}{( {y}_{p} max - {y}_{p} min ) + ( {y}_{g} max - {y}_{g} min )}$$

where yₚ max and yₚ min are the predicated max value of the top layer boundary and the bottom layer boundary, and y_{g} max and y_{g} min are the ground truth max value of the top layer boundary and the bottom layer boundary. This is an example of estimating two layer boundaries, such as ILM and outer boundary of RNFL. Here, ymin is the ILM and ymax is the RNFL for data point subscript “p”.

The training therefore involves regressing (predicting/identifying) the top and the bottom of the (layer) regions of interest directly by using this new formulation.

The problem of retinal layer segmentation is solved by using a Transformer Architecture in the following manner. The architecture consists of:

3. Linear Projection Layers

4. Transformer Layers

5. Output regression with activation and scaling

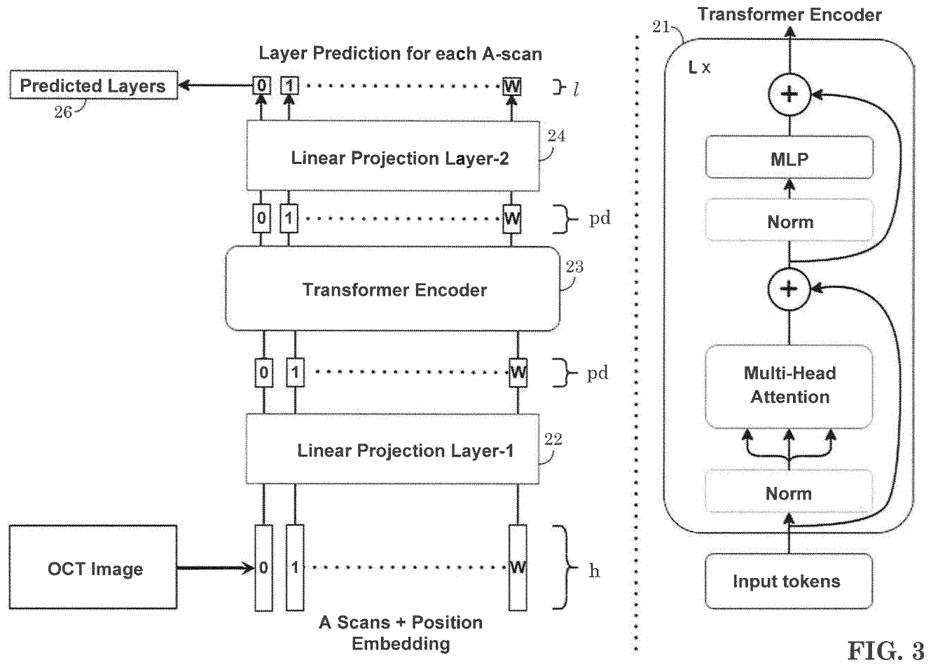

The initial (e.g., first) Linear Projection layer (e.g., Linear Projection Layer-1 in FIG. 3) consists of a dense/fully connected layer that takes in, for example, an input B-scan. The Linear Projection Layer-1 (e.g., comprised by a fully-connected NN layer) converts all A-scans (of any axial/height/depth dimension) in the input B-scan (or C-scan) into a common format with a common axial/height/depth dimension of 128, or other predefined fixed depth dimension, that can be operate upon by the Transformer Encoder. It is noted that the Linear Projection layer-1 maintains the width dimension of the input B-scan (or C-scan), which may be of any indefinite width dimension. Optionally, this first Linear Projection Layer-1 may also provide topology information and/or other features characteristic of layer boundaries.

In various embodiments, one reason the present embodiment can use transformers without adversely affecting the computational complexity is that the problem is reformulated. The Computational cost of running a transformer on a sequence of ‘n’ inputs of ‘d’ dimension is O(n²d). Therefore, for images of size h and w, the computational complexity is: O((hw)²d)=O(h²w²d). In a naive set up, one can let each pixel be a 1d feature, so then d=1 and complexity is: O(h²w²).

In the present set up, each input A-scan (of for example 1024 or other number of samples/pixels) is projected with the first Linear Projection layer-1 to a 128-dimensional feature (d=128), e.g., having a feature height/depth of 128. This effectively translates any input A-scan of any size into a representative 128-dimensional vector having a format suitable for (e.g., expected by) the Transformer encoder. Now there are only ‘w’ sequences (A-scans) of 128 dimension each, and the computational complexity thereby become=O(w²d), which is far less than how transformers are traditionally used for vision tasks. This set up is made possible by the special nature of the OCT A-scan data.

In the present exemplary embodiment, a transformer encoder known as BERT (Bidirectional Encoder Representations from Transformers) is used, as described, for example, in “An image is worth 16×16 words: Transformers for image recognition at scale” by Dosovitskiy, Alexey, et al, arXiv preprint arXiv:2010.11929 (2020), herein incorporated in its entirety by reference. It is to be understood, however, that other transformer-based architectures known in the art may be used.

Here, the input to the transformer is the 128-dimensional vector described earlier. The output of this network is also a 128-dimensional vector, which has been refined. These vectors are then projected directly to layer predictions by a second fully connected linear layer (e.g., Linear Projection Layer-2, 24, in FIG. 3) at the end of the network.

A block diagram of the present workflow described above is illustrated in FIG. 3. In the present embodiment, h is the height of the input OCT image (e.g., number of samples/pixels/data-segments in an A-scan, or the A-scan depth) where the input OCT may be a B-scan or C-scan, w is the width of the OCT image (e.g., the number of A-scans that define the width dimension), l is the number of retinal layers (e.g., one or more) to be predicted, pd is the projected dimension (in the present example, it is 128), and L/Lx is the number of transformer layers (in block 21) that make up the Transformer Encoder 23, which in the present example is 12. For illustration purposes, a single transformer layer Lx, (block 21), is shown. As it would be understood in the art, “input tokens” refer to the inputs to the Transformer Encoder 23, which are provided by Liner Projector Layer-1 22. The output vector from Transformer Encoder 23 is projected directly to layer predictions l by Linear Projection Layer-2, 24, which define the Predicted Layers 26.

The present exemplary network is trained with the L₁ (or L1) loss function, as known in the art. In the present embodiment, since the ground truth data is also generated in an automated manner by a knowledge-based algorithm with a confidence metric, this confidence information is used to further improve the training process. The L₁ loss for every A-scan is weighted by the confidence metric generated by the knowledge-based algorithm. In this manner, a lower weight (e.g., close to, or substantially equal to, 0) is assigned to loss generated at unreliable (e.g., low confidence) ground truth A-scans, and a higher weight (e.g., close to, or substantially equal to, 1) is assigned to loss generated for ground truths that are reliable (corresponding to high confidence positions of ground truth A-scans).

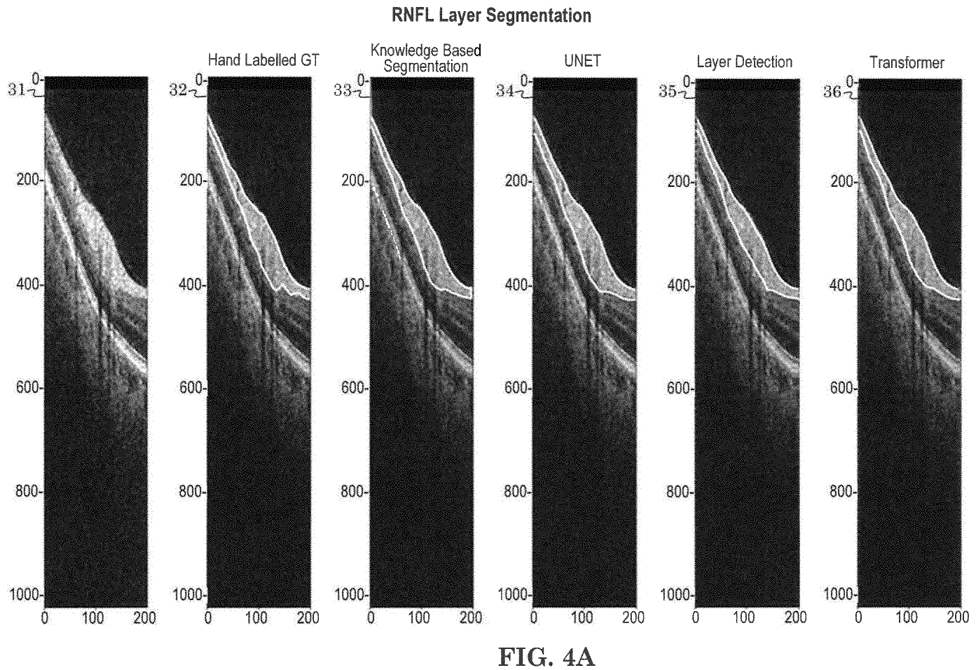

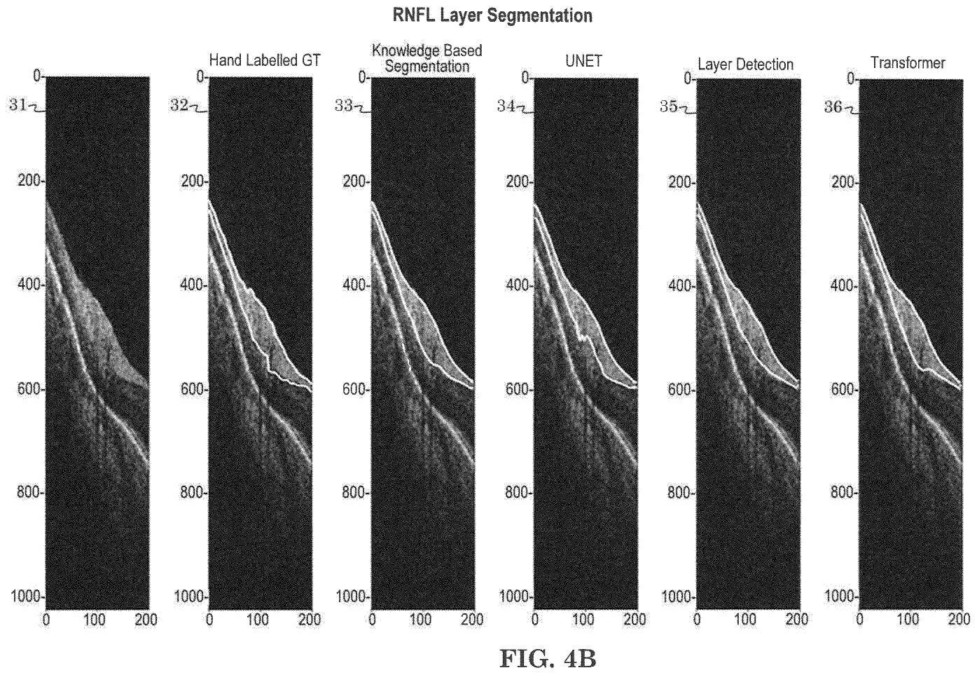

FIGS. 4A and 4B provide some exemplary RNFL segmented images of an OCT image using different segmentation techniques for comparison, including output segmented RNFL images (shown by white solid line) obtain in accordance with the present invention. FIGS. 4A and 4B show an original images 31, the hand labelled ground truths for the OCT slices (images) 32, the knowledge-based segmentation for these images 33, outputs from a standard U-NET based approach for segmentation with later segmenting of the layers from the dense prediction 34, results of directly regressing the layers using Layer Detection 35; and results from the present new transformer method 36.

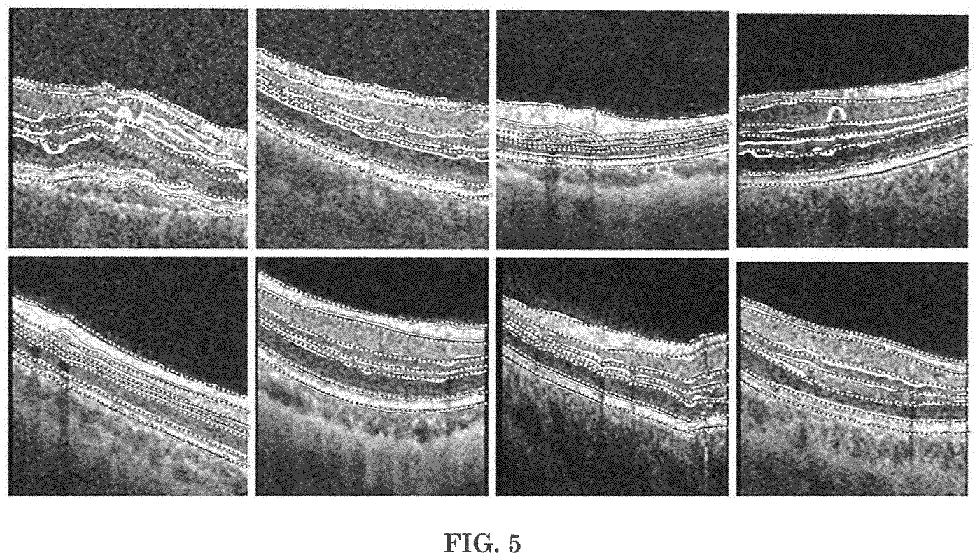

FIG. 5 shows outputs of multi-layer segmentation with segmentation obtained by knowledge-based MLS algorithm in solid white and predicted layer positions (obtained by transformers) shown by dotted white lines. The results obtained by the transformers provide better results in the following manner:
1. Compared to the U-NET based methods, which do not produce a continuous output, the transformer method outputs are much smoother and require no post processing.
2. Compared to direct regression methods, the transformer-based methods do a much more realistic job creating interpolation in regions with low signal quality. The regression methods just draw smooth lines instead of interpolating based on structure (e.g., tissue layer topology).
3. The transformer-based methods are much faster than all the methods shown here. On a 1024×512×512 cube of data, it takes the U-NET model about 10.5 seconds to run the volume, while layer detection takes about 5.3 seconds, and the present Transformer-based approach takes about 1.6 seconds, which makes the present invention suitable for practical clinical applications.

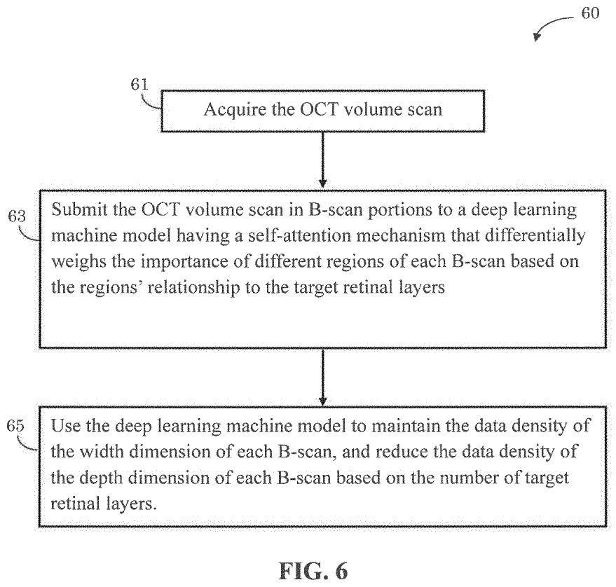

FIG. 6 provides a workflow 60 of an embodiment of the present invention for segmenting one or more target retinal layers from an optical coherence tomography (OCT) volume scan of an eye. A first step 61 is to acquire the OCT volume scan. The OCT volume scan may be acquired using an OCT system, or optionally be accessed from a library of previously collected OCT volumes. The OCT volume scan is submitted in B-scan portions to a deep learning machine model, step 63, having a self-attention mechanism that differentially weighs the importance of different regions of each B-scan based on the regions' relationship to the target retinal layers by enhancing regions of each B-scan associated with the one or more target retinal layers and deemphasizing regions not associated with the target retinal layers. As shown in step 65, the deep learning machine model maintains the data density of the width dimension of each B-scan, and reduces the data density of the depth dimension of each B-scan based on the number of target retinal layers.

Transformers have not appeared to have previously been used for OCT data in this manner. The present approach makes the whole set up very efficient by reducing computational complexity and producing state of the art results. Splitting up an OCT image as a sequence of A-scans can be used in two creative ways, as described above. A main benefit being a significant computational speed increase without losing accuracy. An object detection-like network and a transformer network can be trained using this principle, and both perform well, with transformer network outperforming all other methods. The whole network is trained in a semi-supervised method by using confidence metrics from the knowledge-based algorithms to weigh the losses for the deep learning-based method.

A difficulty with creating a deep learning machine model based on a neural network can be the difficulty in obtaining enough training sets, or training pairs, (e.g. training input data sample and corresponding training target output sample). This requirement can be partially address by data augmentation, which tries to generate new training samples from existing training sample data. However, current data augmentation methods for medical applications, such as OCT image data, have traditionally been limited. Herein is presented a novel method of data augmentation for OCT applications.

Some classical methods of retinal layer segmentation can be replaced with machine learning (ML) and/or deep learning (DL) methods. Still, some methods try to take advantage of both approaches. Mishra, Z. et al., (2020), in “Automated retinal layer segmentation using graph-based algorithm incorporating deep-learning-derived information”, Scientific Reports, 10(1), 1-8, incorporated herein in its entirety by reference, describes a method that takes probability maps generated through a fully convolutional neural network and applies a shortest-path algorithm to them to estimate final segmentation masks.

Most DL methods are based on U-Net structure and try to predict layers assignment for each pixel. Two examples of method based on U-Net structure are disclosed in De Fauw et al, (2018), “Clinically applicable deep learning for diagnosis and referral in retinal disease”, Nature medicine, 24(9), 1342-1350, and in Yadav, S. K. et al., (2021), “Deep Learning based Intraretinal Layer Segmentation using Cascaded Compressed U-Net”, medRxiv, both herein incorporated in their entirety by reference. U-Net is an Encoder-Decoder network that might be suitable for pixel-level prediction tasks such as semantic segmentation, but it is slow and inaccurate for layer boundary detection. To handle this task, some methods have tried to develop different network architectures, including fully convolutional networks, as described by Anoop, B. N. et al., (2020), in “Stack generalized deep ensemble learning for retinal layer segmentation in optical coherence tomography images,” Biocybernetics and Biomedical Engineering, 40(4), 1343-1358, herein incorporated in its entirety by reference. In, “Clinically applicable deep learning for diagnosis and referral in retinal disease,” Nature medicine, (2018), 24(9), 1342-1350, herein incorporated in its entirety by reference, De Fauw et al. describe a classification from the segmentation framework. Given any scan cube, the method first performs 3D layer segmentation using a 3D U-Net network and uses its output to perform the final diagnosis and referral tasks. While the segmentation modules generate masks for 15 different anatomies, pathology, and image artifact, the method does not focus on generating accurate B-scan level layer segmentation. Most of these prior art techniques use general data augmentation methods used in a typical deep learning framework. While those augmentations are necessary, they are not sufficient. There have been many attempts to use Generative Adversarial Networks (GAN) to augment OCT data for better training of ML models, as described, for example, in “Data augmentation for patch-based OCT choroid-retinal segmentation using generative adversarial networks”, 2021, Neural Computing and Applications, 33(13), 7393-7408, by Kugelman, J. et al., herein incorporated in its entirety by reference. Training such GANs is complex, time-consuming, and, most important, there is no generative method capable of generating ground-truth layer masks in addition to the OCT images.

Herein is proposed an augmentation method to make the machine model generalize well to different noise levels and complex disease cases. The present approach performs spectral-domain (e.g., raw OCT data) augmentation, time-domain global augmentations, and local morphing. The present neural network architecture may have a minimal fully-convolutional network, but other networks are possible and contemplated in the present invention. A training regime in accordance with this embodiment/approach may include pre-training the machine model on a vast corpus of unlabeled data to generate a strong representation of the input B-scans, and fine-tuning the machine model on ground truth samples acquired from existing classical methods. The present approach provides for effectively using data from a knowledge-based model to train a deep learning machine model. The present approach may use confidence values generated alongside the retinal layers from a classical method to filter out week training data, as discussed above. Confidence values in the cost function of the deep learning machine model may also be incorporated. The values may be added as regularization terms directly to the cost function.

Regarding data augmentation, the described local warping technique has not been used by any other method on OCT data. The present spectral-domain (e.g., raw OCT data) method of data augmentation is also unique to the data generation and workflow pipeline. As for the present deep learning method(s), the cost function is deemed novel. The below combination of neural network structure and self-supervised approach enables enhancement of the operation of the retinal layer segmentation from OCT images. Also, the above-described novel deep learning machine models may also be used with the present novel features.

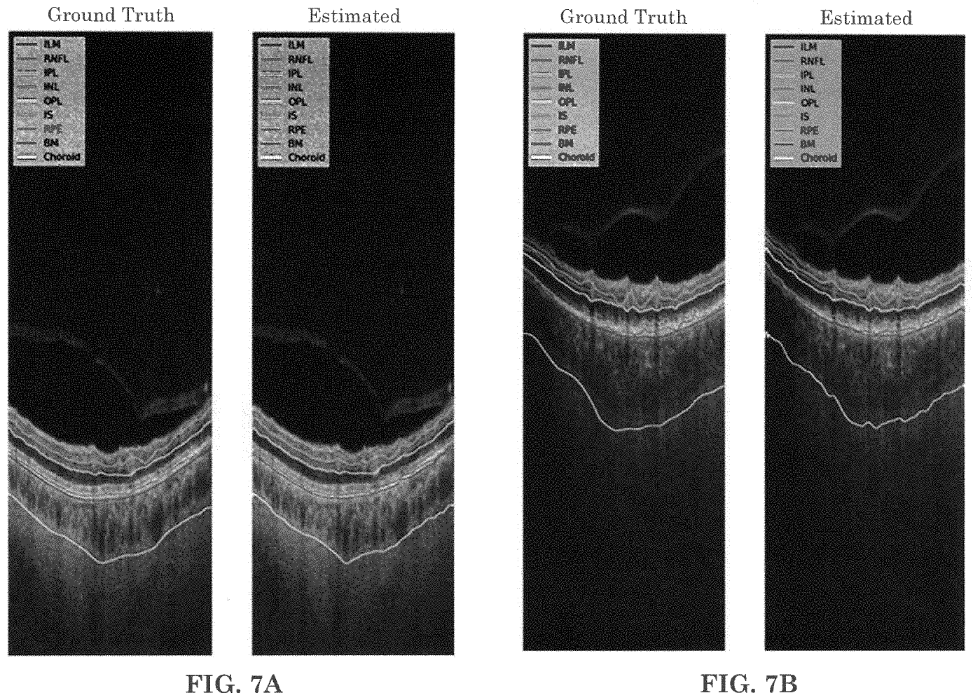

FIGS. 7A and 7B show two respective sample images with one having ground-truth retinal layers (as labeled) and the other having estimated/predicted retinal layers from the present initial machine model. Hereinbelow, three data augmentation methods are described: global time-domain augmentation, augmentation based on local warping, and spectral domain augmentation.

A: Global Time-Domain Augmentation

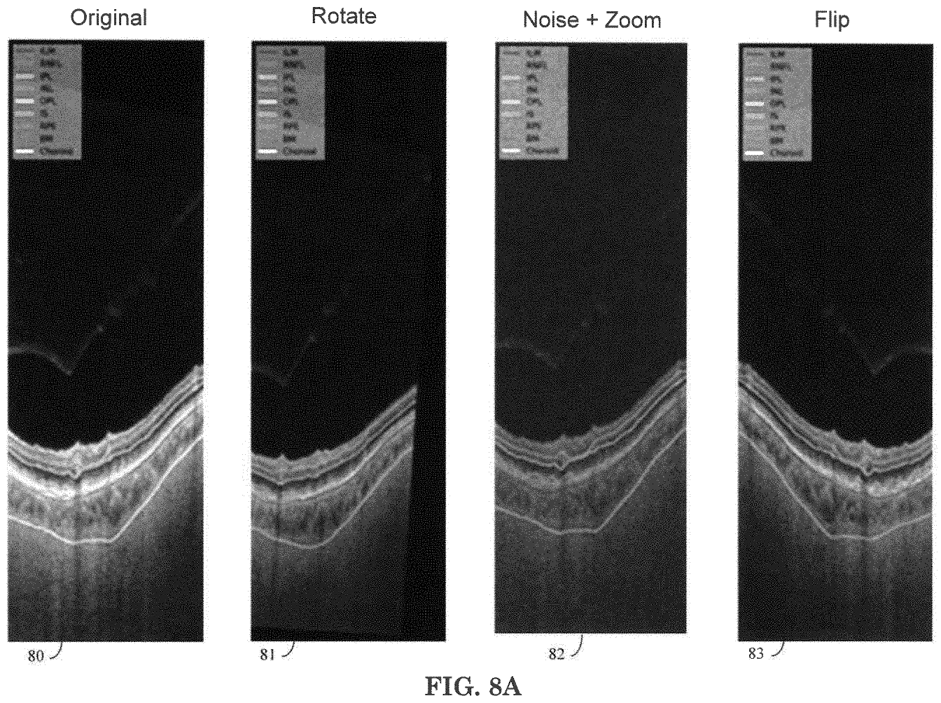

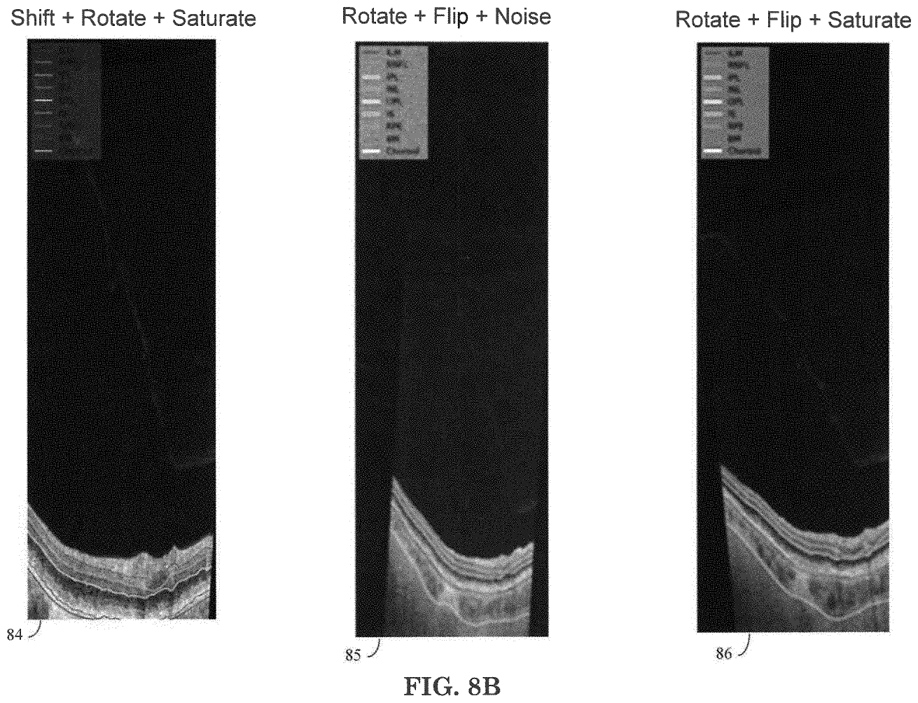

This approach applies extensive global augmentations (e.g., affine, adding noise, adjust brightness, and contrast) to the training data to create additional training samples and have more robust machine models and increase the generalizability of the trained machine models. FIGS. 8A and 8B illustrate examples of some global time-domain data augmentation, including the original (B-scan) image 80 (with labeled retinal layers) from which the augmented data samples are based. Also shown are more representations/renditions of the original image 80, including the original image after being rotated (amended image 81), the original image after zooming in and adding noise 82, the original image flipped 83, the original image shifted, rotated and saturated 84, the original image rotated and flipped with added noise 85, and the original image rotated, flipped and saturated 86. Each of the amended images 81-86 defines an additional image (e.g., augmented data) that can be used for training in addition to the original image 80.

B: Local Warping

Two significant limitations of existing data that restrict the generalizability of any deep learning machine model trained on this data are: (1) collecting data with all possible retinal diseases and variations is challenging; and (2) even if one can collect such data, the classical MLS tools will have difficulties generating reliable ground-truth retinal segmentation.

While global augmentations, as listed immediately above, will make deep learning models invariant to global geometric or photometric variations, they will not address local variations, such as can occur due to various diseases. Herein is presented a local warping method to deal with this issue. Local warping aims to simulate various pathologies, which can also include changes to OCT reflectivity (e.g., reflectivity changes that corresponds to specific pathology or pathologies). This approach thus provides local warping (changes in shape) and reflectivity changes (e.g., changes in intensity) to simulate different deformations/image artifacts characteristic of one or more specific disease. For example, Age-Related Macular Degeneration (AMD) is a main concern, but other diseases, such as diabetic retinopathy (DR), Glaucoma, vitreoretinal interface (VRI), and a combination of other diseases and deformations will be considered in the simulation (e.g., using the present data augmentation approach). This method will help the DL models learn the shape of the pathologies even without perfect simulations of them. This method differs from GANs since it provides complete control over generated images and corresponding layer boundaries, which is impossible in generative models (e.g., GAN).

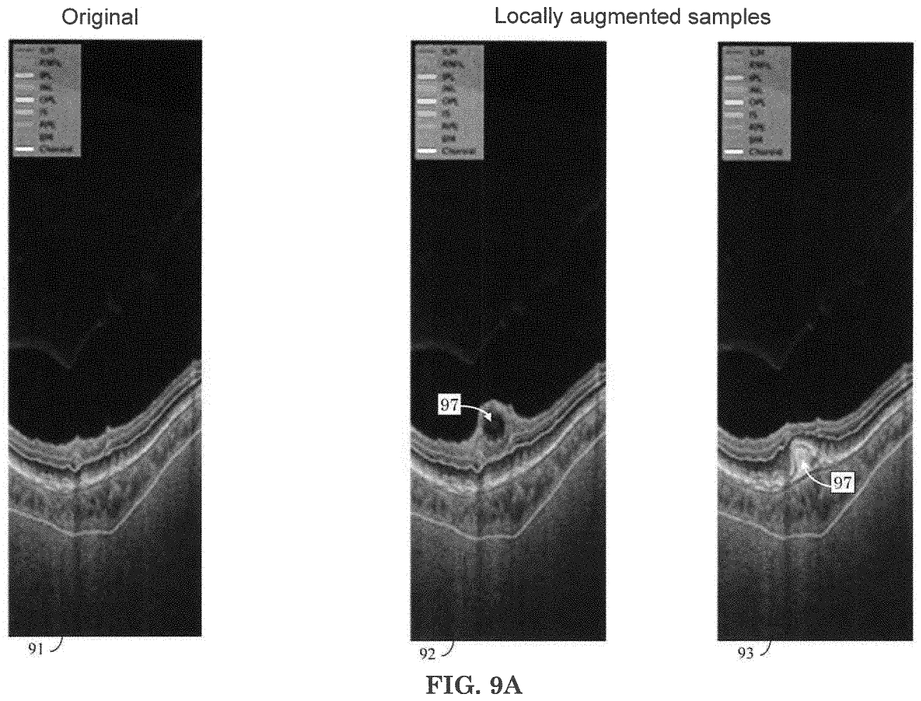

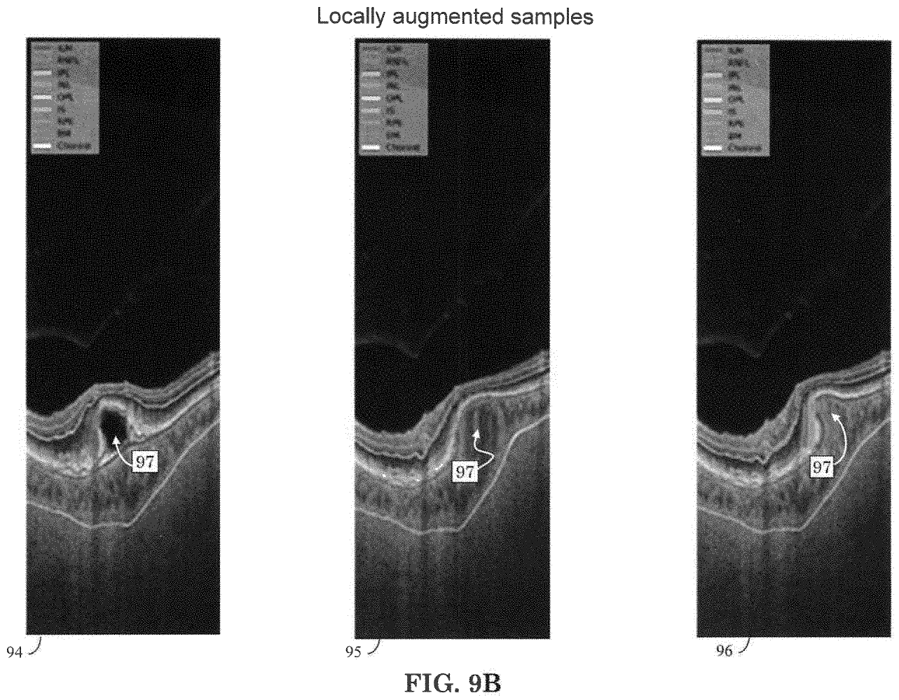

The present disease simulation includes two steps. The shape of the retina is morphed in specific locations, and then the intensities are adjusted, or vise vera. This approach may be applied to ground truth examples that have already been labeled. Applying local warping on data with ground-truth layers with annotation significantly increases the diversity of data, since the retinal layer labels accurately carry forward to the warped/amended data, and no new/additional segmentation labels for the morphed image is needed. The method has complete control over the warping parameters and can apply the same augmentation to both B-scans and the associated layer annotations. For illustration purposes, FIGS. 9A and 9B provide B-scan images including one original B-scan 91, and various data augmentation B-scans 92-96 generated from the original B-scan 91 by applying the present local augmentations (e.g., local morphing) techniques. A shown, images of various data augmentation B-scans 92-96 demonstrate various levels and locations of local morphing 97 while maintaining consistent retinal segmentation labels (e.g., demarcations illustrated as bright lines).

C1: Spectral Domain Augmentations

The present approach provides OCT data augmentation in the spectral domain to deal with low axial resolution data. The present approach amends raw OCT data to define additional training samples, as opposed to applying data augmentation to OCT imaged data (e.g., after applying Fourier transfer to raw OCT data).

Layer segmentation on low axial resolution data is essential for low-cost OCT devices. While adjusting a classical method to work on low-resolution images is challenging, deep learning machine models could be trained to work on super low-resolution images. To train a robust model to work on images with a low axial resolution, the present approach may include the following four features:

1A: Collect spectral data with high-resolution and reconstruct OCT cubes (volume scans);

2A: Apply existing MLS models that perform well on high-resolution data to generate gold-standard layer segmentation (e.g., from the constructed high-resolution OCT cubes);

3A: Degrade the spectral data to lower resolution with various degrees and reconstruct low-resolution OCT cubes, e.g., low-resolution images, (from the degraded spectral (or raw OCT) data);

4A: Use these low-resolution images and the gold-standard layer annotation from step (2A) as input to train a neural network and define the deep learning machine model.

C2: Augmentation in the Spectral Domain to Handle Noise

Adding noise in the spectral domain (raw OCT data) is a unique augmentation in our method. It is challenging to simulate noise observed on OCT data only in the time (e.g., image) domain. Therefore, the present approach takes advantage of having access to the raw OCT signal to do so. This process may include:

1B: Store noise scans during acquisition;

2B: Reconstruct OCT image;

3B: Apply existing MLS models that perform well on low-noise data to generate gold-standard layer segmentation;

4B: Sample noise from stored noise scans and apply to the raw signal and reconstruct the resultant noisy images;

5B: Use these noisy images as input and gold-standard layer annotation from step (2B) to train the neural network and define the deep learning machine model.

Additional data augmentations that may be made in the spectral domain include:

1C: Shift and sheer B-scans axially in the spectral domain;

2C: Change contrast in spectral domain, as opposed to changing contrast in time-domain (e.g., multiplication of an image with a scalar), which is equivalent to multiplication with another constant in the spectral domain.

1C: Adjusting brightness of the signal. In the time domain, this may be achieved by adding a scalar to the image data, but in the spectral domain this may be achieved by adding a constant to the zero-frequency component.

Exemplary Network Architecture

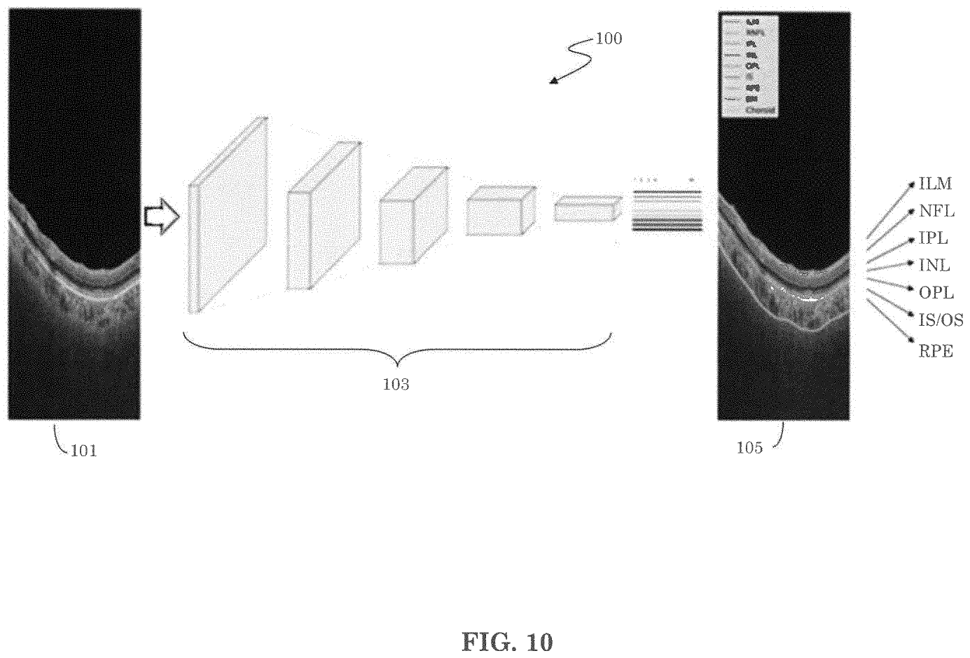

The present data augmentation methods may be used with the above-described neural network architectures, or with any other NN architectures. For illustration purpose, herein is presented another NN approach. FIG. 10 illustrates present neural network example 100, which is fully convolutional. An input image 101 goes through several convolutions and down-sampling layers 103 to reduce the size of feature maps to a matrix of 9×W, where W is the width of the input image 101. Each line of this 9×W matrix represents a boundary line for one of the nine retina layers, which can be used to label an output image 105, as shown. Again, the individual retinal layers are shown in bright lines. For illustration purposes, the labeled/shown retinal layers include the Inner Limiting Membrane (ILM), Nerve Fiber Layer (NFL), Inner Plexiform Layer (IPL), Inner Nuclear Layer (INL), Outer Plexiform Layer (OPL), Outer Segments and Inner Segments junction (IS/OS), and Retinal Pigment Epithelium (RPE). Downsampling layers are performed only in the vertical (axial) direction while keeping the width of feature maps (W) the same size as the input image 101. The fully convolutional nature of the model, plus the pre-training procedure and augmentations used during training, makes the present deep learning machine model generalizable to various scan patterns of different sizes

Training Procedure

The network is pre-trained using self-supervised approach (e.g., SimClr, a framework for contrastive learning of visual representations) on data without ground-truth segmentation.

Data Collection

Manual labeling of data for this task is tedious. Therefore, the present approach uses the segmentation output of an existing knowledge-based (MLS) algorithm to train the present deep learning network. Consequently, the ground truth samples (e.g., training samples) resulting from the MLS may not be flawless. Thus, a question that arises is, how to train a deep learning machine model that performs better than its classical teacher (e.g., the outputs from the MLS)? To answer this question, two methods are developed to alleviate imperfections in the ground-truth data:

1E: Filter out samples in which the classical method has extremely low confidence;

2E: Incorporate confidence values generated by the classical method (alongside the layer segmentation) in the cost function of the deep learning machine model during training.

Cost Function

The cost function used to train the primary machine model comprises two main terms, data and regularization. While the data term may be a simple L1 or L2 loss, various components will form the regularization term:

1F: Confidence values of the ground-truth data generated by classical model;

2F: Smoothing terms;

3F Some terms used to enforce a physical limitation of layer boundaries (distance transform of the binary image calculated from the ground-truth layer positions painted in a blank image);

4F: Incorporate cost images used by classical MLS, where cost images are defined as weighted average of one or more processed segmentation regions or B-scans that are used for segmentation (examples for processed segmentation regions are axial gradient, gradient of magnitude, filtered intensity image, or filtered inverted intensity image, etc.).

Hereinafter is provided a description of various hardware and architectures suitable for the present invention.

Fundus Imaging System

Two categories of imaging systems used to image the fundus are flood illumination imaging systems (or flood illumination imagers) and scan illumination imaging systems (or scan imagers). Flood illumination imagers flood with light an entire field of view (FOV) of interest of a specimen at the same time, such as by use of a flash lamp, and capture a full-frame image of the specimen (e.g., the fundus) with a full-frame camera (e.g., a camera having a two-dimensional (2D) photo sensor array of sufficient size to capture the desired FOV, as a whole). For example, a flood illumination fundus imager would flood the fundus of an eye with light, and capture a full-frame image of the fundus in a single image capture sequence of the camera. A scan imager provides a scan beam scanned across a subject, e.g., an eye, and the scan beam is imaged at different scan positions as it is scanned across the subject creating a series of image-segments that may be reconstructed, e.g., montaged, to create a composite image of the desired FOV. The scan beam could be a point, a line, or a two-dimensional area such a slit or broad line. Examples of fundus imagers are provided in U.S. Pat. Nos. 8,967,806 and 8,998,411.

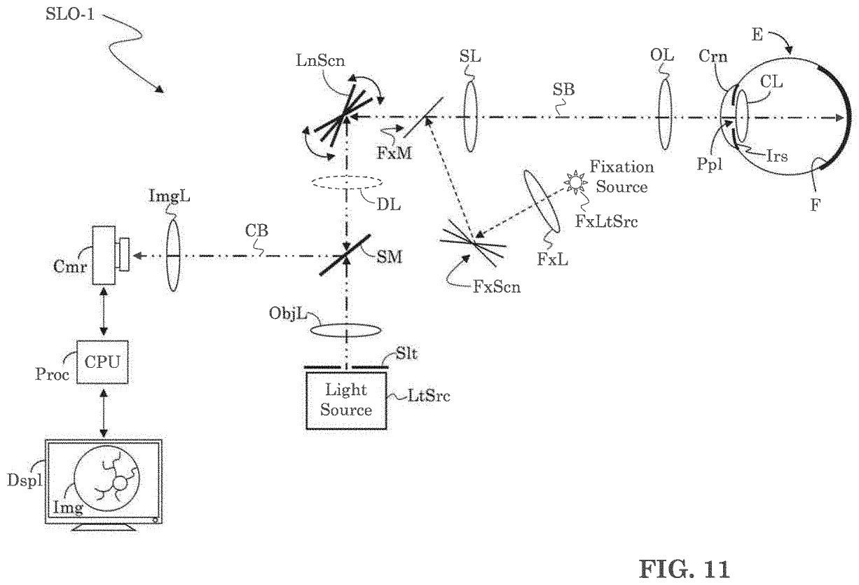

FIG. 11 illustrates an example of a slit scanning ophthalmic system SLO-1 for imaging a fundus F, which is the interior surface of an eye E opposite the eye lens (or crystalline lens) CL and may include the retina, optic disc, macula, fovea, and posterior pole. In the present example, the imaging system is in a so-called “scan-descan” configuration, wherein a scanning line beam SB traverses the optical components of the eye E (including the cornea Cm, iris Irs, pupil Ppl, and crystalline lens CL) to be scanned across the fundus F. In the case of a flood fundus imager, no scanner is needed, and the light is applied across the entire, desired field of view (FOV) at once. Other scanning configurations are known in the art, and the specific scanning configuration is not critical to the present invention. As depicted, the imaging system includes one or more light sources LtSrc, preferably a multi-color LED system or a laser system in which the etendue has been suitably adjusted. An optional slit Slt (adjustable or static) is positioned in front of the light source LtSrc and may adjust the width of the scanning line beam SB. Also, slit Slt may remain static during imaging or may be adjusted to different widths to allow for different confocality levels and different applications either for a particular scan or during the scan for suppressing reflexes. An optional objective lens ObjL may be placed in front of the slit Slt. The objective lens ObjL can be any one of state-of-the-art lenses including but not limited to refractive, diffractive, reflective, or hybrid lenses/systems. The light from slit Slt passes through a pupil splitting mirror SM and is directed towards a scanner LnScn. It is desirable to bring the scanning plane and the pupil plane as near together as possible to reduce vignetting in the system. Optional optics DL may be included to manipulate the optical distance between the images of the two components. Pupil splitting mirror SM may pass an illumination beam from light source LtSrc to scanner LnScn, and reflect a detection beam from scanner LnScn (e.g., reflected light returning from eye E) toward a camera Cmr. A task of the pupil splitting mirror SM is to split the illumination and detection beams and to aid in the suppression of system reflexes. The scanner LnScn could be a rotating galvo scanner or other types of scanners (e.g., piezo or voice coil, micro-electromechanical system (MEMS) scanners, electro-optical deflectors, and/or rotating polygon scanners). Depending on whether the pupil splitting is done before or after the scanner LnScn, the scanning could be broken into two steps wherein one scanner is in an illumination path and a separate scanner is in a detection path. Specific pupil splitting arrangements are described in U.S. Pat. No. 9,456,746, which is herein incorporated in its entirety by reference.

From the scanner LnScn, the illumination beam passes through one or more optics, a scanning lens SL and an ophthalmic or ocular lens OL, that allow for the pupil of the eye E to be imaged to an image pupil of the system. Generally, the scan lens SL receives a scanning illumination beam from the scanner LnScn at any of multiple scan angles (incident angles), and produces scanning line beam SB with a substantially flat surface focal plane (e.g., a collimated light path). Ophthalmic lens OL may then focus the scanning line beam SB onto an object to be imaged. In the present example, ophthalmic lens OL focuses the scanning line beam SB onto the fundus F (or retina) of eye E to image the fundus. In this manner, scanning line beam SB creates a traversing scan line that travels across the fundus F. One possible configuration for these optics is a Kepler type telescope wherein the distance between the two lenses is selected to create an about telecentric intermediate fundus image (4-f configuration). The ophthalmic lens OL could be a single lens, an achromatic lens, or an arrangement of different lenses. All lenses could be refractive, diffractive, reflective or hybrid as known to one skilled in the art. The focal length(s) of the ophthalmic lens OL, scan lens SL and the size and/or form of the pupil splitting mirror SM and scanner LnScn could be different depending on the desired field of view (FOV), and so an arrangement in which multiple components can be switched in and out of the beam path, for example by using a flip in optic, a motorized wheel, or a detachable optical element, depending on the field of view can be envisioned. Since the field of view change results in a different beam size on the pupil, the pupil splitting can also be changed in conjunction with the change to the FOV. For example, a 45° to 60° field of view is a typical, or standard, FOV for fundus cameras. Higher fields of view, e.g., a widefield FOV, of 60°-120°, or more, may also be feasible. A widefield FOV may be desired for a combination of the Broad-Line Fundus Imager (BLFI) with another imaging modalities such as optical coherence tomography (OCT). The upper limit for the field of view may be determined by the accessible working distance in combination with the physiological conditions around the human eye. Because a typical human retina has a FOV of 140° horizontal and 80°-100° vertical, it may be desirable to have an asymmetrical field of view for the highest possible FOV on the system.

The scanning line beam SB passes through the pupil Ppl of the eye E and is directed towards the retinal, or fundus, surface F. The scanner LnScn1 adjusts the location of the light on the retina, or fundus, F such that a range of transverse locations on the eye E are illuminated. Reflected or scattered light (or emitted light in the case of fluorescence imaging) is directed back along as similar path as the illumination to define a collection beam CB on a detection path to camera Cmr.

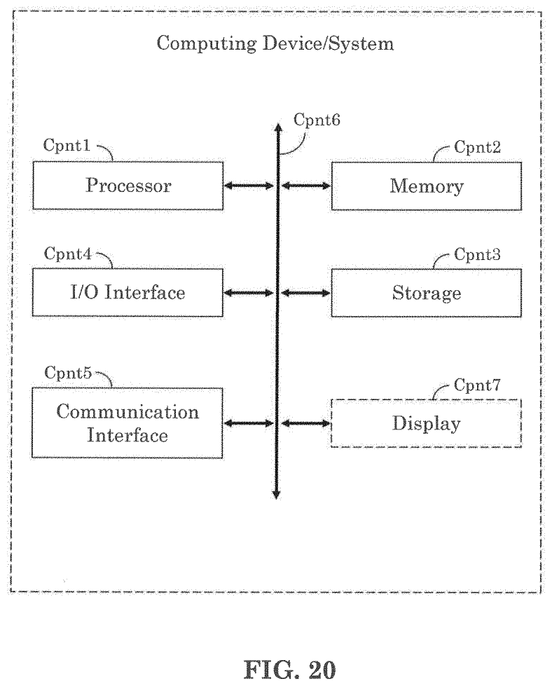

In the “scan-descan” configuration of the present, exemplary slit scanning ophthalmic system SLO-1, light returning from the eye E is “descanned” by scanner LnScn on its way to pupil splitting mirror SM. That is, scanner LnScn scans the illumination beam from pupil splitting mirror SM to define the scanning illumination beam SB across eye E, but since scanner LnScn also receives returning light from eye E at the same scan position, scanner LnScn has the effect of descanning the returning light (e.g., cancelling the scanning action) to define a non-scanning (e.g., steady or stationary) collection beam from scanner LnScn to pupil splitting mirror SM, which folds the collection beam toward camera Cmr. At the pupil splitting mirror SM, the reflected light (or emitted light in the case of fluorescence imaging) is separated from the illumination light onto the detection path directed towards camera Cmr, which may be a digital camera having a photo sensor to capture an image. An imaging (e.g., objective) lens ImgL may be positioned in the detection path to image the fundus to the camera Cmr. As is the case for objective lens ObjL, imaging lens ImgL may be any type of lens known in the art (e.g., refractive, diffractive, reflective or hybrid lens). Additional operational details, in particular, ways to reduce artifacts in images, are described in PCT Publication No. WO2016/124644, the contents of which are herein incorporated in their entirety by reference. The camera Cmr captures the received image, e.g., it creates an image file, which can be further processed by one or more (electronic) processors or computing devices (e.g., the computer system of FIG. 20). Thus, the collection beam (returning from all scan positions of the scanning line beam SB) is collected by the camera Cmr, and a full-frame image Img may be constructed from a composite of the individually captured collection beams, such as by montaging. However, other scanning configuration are also contemplated, including ones where the illumination beam is scanned across the eye E and the collection beam is scanned across a photo sensor array of the camera. PCT Publication WO 2012/059236 and US Patent Publication No. 2015/0131050, herein incorporated by reference, describe several embodiments of slit scanning ophthalmoscopes including various designs where the returning light is swept across the camera's photo sensor array and where the returning light is not swept across the camera's photo sensor array.

In the present example, the camera Cmr is connected to a processor (e.g., processing module) Proc and a display (e.g., displaying module, computer screen, electronic screen, etc.) Dspl, both of which can be part of the image system itself, or may be part of separate, dedicated processing and/or displaying unit(s), such as a computer system wherein data is passed from the camera Cmr to the computer system over a cable or computer network including wireless networks. The display and processor can be an all in one unit. The display can be a traditional electronic display/screen or of the touch screen type and can include a user interface for displaying information to and receiving information from an instrument operator, or user. The user can interact with the display using any type of user input device as known in the art including, but not limited to, mouse, knobs, buttons, pointer, and touch screen.

It may be desirable for a patient's gaze to remain fixed while imaging is carried out. One way to achieve this is to provide a fixation target that the patient can be directed to stare at. Fixation targets can be internal or external to the instrument depending on what area of the eye is to be imaged. One embodiment of an internal fixation target is shown in FIG. 11. In addition to the primary light source LtSrc used for imaging, a second optional light source FxLtSrc, such as one or more LEDs, can be positioned such that a light pattern is imaged to the retina using lens FxL, scanning element FxScn and reflector/mirror FxM. Fixation scanner FxScn can move the position of the light pattern and reflector FxM directs the light pattern from fixation scanner FxScn to the fundus F of eye E. Preferably, fixation scanner FxScn is position such that it is located at the pupil plane of the system so that the light pattern on the retina/fundus can be moved depending on the desired fixation location.

Slit-scanning ophthalmoscope systems can operate in different imaging modes depending on the light source and wavelength selective filtering elements employed. True color reflectance imaging (imaging similar to that observed by the clinician when examining the eye using a hand-held or slit lamp ophthalmoscope) can be achieved when imaging the eye with a sequence of colored LEDs (red, blue, and green). Images of each color can be built up in steps with each LED turned on at each scanning position or each color image can be taken in its entirety separately. The three, color images can be combined to display the true color image, or they can be displayed individually to highlight different features of the retina. The red channel best highlights the choroid, the green channel highlights the retina, and the blue channel highlights the anterior retinal layers. Also, light at specific frequencies (e.g., individual colored LEDs or lasers) can excite different fluorophores in the eye (e.g., autofluorescence) and the resulting fluorescence can be detected by filtering out the excitation wavelength.

The fundus imaging system can also provide an infrared reflectance image, such as by using an infrared laser (or other infrared light source). The infrared (IR) mode is advantageous because the eye is not sensitive to the IR wavelengths. This may permit a user to continuously take images without disturbing the eye (e.g., in a preview/alignment mode) to aid the user during alignment of the instrument. Also, the IR wavelengths have increased penetration through tissue and may provide improved visualization of choroidal structures. In addition, fluorescein angiography (FA) and indocyanine green (ICG) angiography imaging can be done by collecting images after a fluorescent dye has been injected into the bloodstream. For example, in FA (and/or ICG) a series of time-lapse images may be captured after injecting a light-reactive dye (e.g., fluorescent dye) into a subject's bloodstream. It is noted that care must be taken since the fluorescent dye may lead to a life-threatening allergic reaction in a portion of the population. High contrast, greyscale images are captured using specific light frequencies selected to excite the dye. As the dye flows through the eye, many parts of the eye are made to glow brightly (e.g., fluoresce), making it possible to discern the progress of the dye, and hence the blood flow, through the eye.

Optical Coherence Tomography Imaging System

Generally, optical coherence tomography (OCT) uses low-coherence light to produce two-dimensional (2D) and three-dimensional (3D) internal views of biological tissue. OCT enables in vivo imaging of retinal structures. OCT angiography (OCTA) produces flow information, such as vascular flow from within the retina. Examples of OCT systems are provided in U.S. Pat. Nos. 6,741,359 and 9,706,915, and examples of an OCTA systems may be found in U.S. Pat. Nos. 9,700,206 and 9,759,544, which are herein incorporated in their entirety by reference. An exemplary OCT/OCTA system is provided herein.

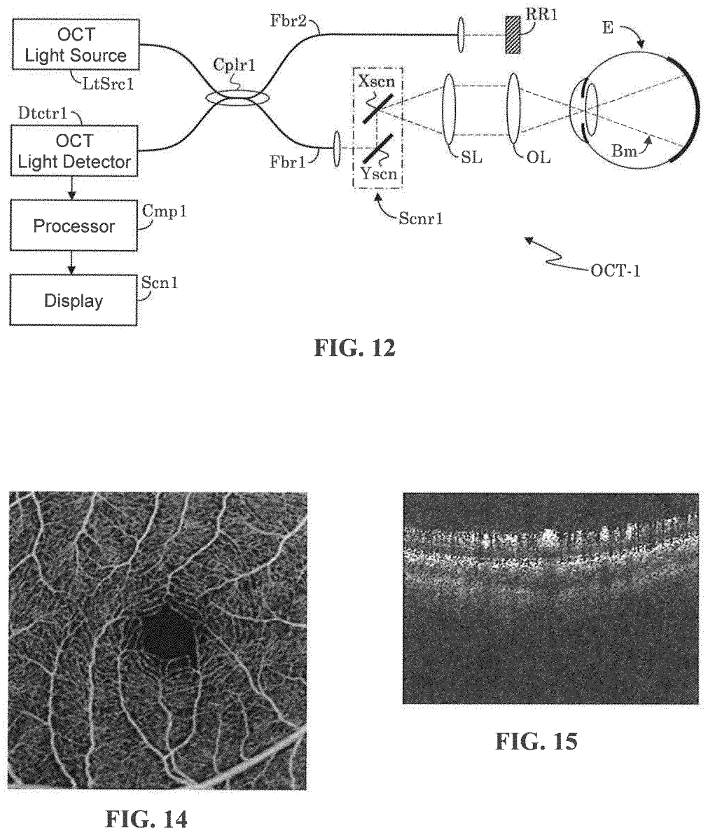

FIG. 12 illustrates a generalized frequency domain optical coherence tomography (FD-OCT) system used to collect 3D image data of the eye suitable for use with the present invention. An FD-OCT system OCT_1 includes a light source, LtSrc1. Typical light sources include, but are not limited to, broadband light sources with short temporal coherence lengths or swept laser sources. A beam of light from light source LtSrc1 is routed, typically by optical fiber Fbr1, to illuminate a sample, e.g., eye E; a typical sample being tissues in the human eye. The light source LrSrc1 may, for example, be a broadband light source with short temporal coherence length in spectral domain OCT (SD-OCT) or a wavelength tunable laser source in swept source OCT (SS-OCT). The light may be scanned, typically with a scanner Scnr1 between the output of the optical fiber Fbr1 and the sample E, so the beam of light (dashed line Bm) is scanned laterally over the region of the sample to be imaged. The light beam from scanner Scnr1 may pass through a scan lens SL and an ophthalmic lens OL and be focused onto the sample E being imaged. The scan lens SL may receive the beam of light from the scanner Scnr1 at multiple incident angles and produce substantially collimated light, and ophthalmic lens OL may then focus onto the sample. The present example illustrates a scan beam that needs to be scanned in two lateral directions (e.g., in x and y directions on a Cartesian plane) to scan a desired field of view (FOV). An example of this would be a point-field OCT, which uses a point-field beam to scan across a sample. Scanner Scnr1 is illustratively shown to include two sub-scanner: a first sub-scanner Xscn for scanning the point-field beam across the sample in a first direction (e.g., a horizontal x-direction); and a second sub-scanner Yscn for scanning the point-field beam on the sample in traversing second direction (e.g., a vertical y-direction). If the scan beam were a line-field beam (e.g., a line-field OCT), which may sample an entire line-portion of the sample at a time, then only one scanner may be needed to scan the line-field beam across the sample to span the desired FOV. If the scan beam were a full-field beam (e.g., a full-field OCT), no scanner may be needed, and the full-field light beam may be applied across the entire, desired FOV at once.

Irrespective of the type of beam used, light scattered from the sample (e.g., sample light) is collected. In the present example, scattered light returning from the sample is collected into the same optical fiber Fbr1 used to route the light for illumination. Reference light derived from the same light source LtSrc1 travels a separate path, in this case involving optical fiber Fbr2 and retro-reflector RR1 with an adjustable optical delay. Those skilled in the art will recognize that a transmissive reference path can also be used and that the adjustable delay could be placed in the sample or reference arm of the interferometer. Collected sample light is combined with reference light, for example, in a fiber coupler Cplr1, to form light interference in an OCT light detector Dtctr1 (e.g., photodetector array, digital camera, etc.). Although a single fiber port is shown going to the detector Dtctr1, those skilled in the art will recognize that various designs of interferometers can be used for balanced or unbalanced detection of the interference signal. The output from the detector Dtctr1 is supplied to a processor (e.g., internal or external computing device) Cmp1 that converts the observed interference into depth information of the sample. The depth information may be stored in a memory associated with the processor Cmp1 and/or displayed on a display (e.g., computer/electronic display/screen) Scn1. The processing and storing functions may be localized within the OCT instrument, or functions may be offloaded onto (e.g., performed on) an external processor (e.g., an external computing device), to which the collected data may be transferred. An example of a computing device (or computer system) is shown in FIG. 20. This unit could be dedicated to data processing or perform other tasks which are quite general and not dedicated to the OCT device. The processor (computing device) Cmp1 may include, for example, a field-programmable gate array (FPGA), a digital signal processor (DSP), an application specific integrated circuit (ASIC), a graphics processing unit (GPU), a system on chip (SoC), a central processing unit (CPU), a general purpose graphics processing unit (GPGPU), or a combination thereof, that may performs some, or the entire, processing steps in a serial and/or parallelized fashion with one or more host processors and/or one or more external computing devices.

The sample and reference arms in the interferometer could consist of bulk-optics, fiber-optics, or hybrid bulk-optic systems and could have different architectures such as Michelson, Mach-Zehnder or common-path based designs as known by those skilled in the art. Light beam as used herein should be interpreted as any carefully directed light path. Instead of mechanically scanning the beam, a field of light can illuminate a one or two-dimensional area of the retina to generate the OCT data (see for example, U.S. Pat. No. 9,332,902; D. Hillmann et al, “Holoscopy—Holographic Optical Coherence Tomography,” Optics Letters, 36(13): 2390 2011; Y. Nakamura, et al, “High-Speed Three Dimensional Human Retinal Imaging by Line Field Spectral Domain Optical Coherence Tomography,” Optics Express, 15(12):7103 2007; Blazkiewicz et al, “Signal-To-Noise Ratio Study of Full-Field Fourier-Domain Optical Coherence Tomography,” Applied Optics, 44(36):7722 (2005)). In time-domain systems, the reference arm needs to have a tunable optical delay to generate interference. Balanced detection systems are typically used in TD-OCT and SS-OCT systems, while spectrometers are used at the detection port for SD-OCT systems. The invention described herein could be applied to any type of OCT system. Various aspects of the invention could apply to any type of OCT system or other types of ophthalmic diagnostic systems and/or multiple ophthalmic diagnostic systems including but not limited to fundus imaging systems, visual field test devices, and scanning laser polarimeters.

In Fourier Domain optical coherence tomography (FD-OCT), each measurement is the real-valued spectral interferogram (Sj(k)). The real-valued spectral data typically goes through several post-processing steps including background subtraction, dispersion correction, etc. The Fourier transform of the processed interferogram, results in a complex valued OCT signal output Aj(z)=|Aj|eiφ. The absolute value of this complex OCT signal, |Aj|, reveals the profile of scattering intensities at different path lengths, and therefore scattering as a function of depth (z-direction) in the sample. Similarly, the phase, φj can also be extracted from the complex valued OCT signal. The profile of scattering as a function of depth is called an axial scan (A-scan). A set of A-scans measured at neighboring locations in the sample produces a cross-sectional image (tomogram or B-scan) of the sample. A collection of B-scans collected at different transverse locations on the sample makes up a data volume or cube. For a particular volume of data, the term fast axis refers to the scan direction along a single B-scan whereas slow axis refers to the axis along which multiple B-scans are collected. The term “cluster scan” may refer to a single unit or block of data generated by repeated acquisitions at the same (or substantially the same) location (or region) to analyze motion contrast, which may identify blood flow. A cluster scan can consist of multiple A-scans or B-scans collected with relatively short time separations at about the same location(s) on the sample. Since the scans in a cluster scan are of the same region, static structures remain relatively unchanged from scan to scan within the cluster scan, whereas motion contrast between the scans that meets predefined criteria may be identified as blood flow.

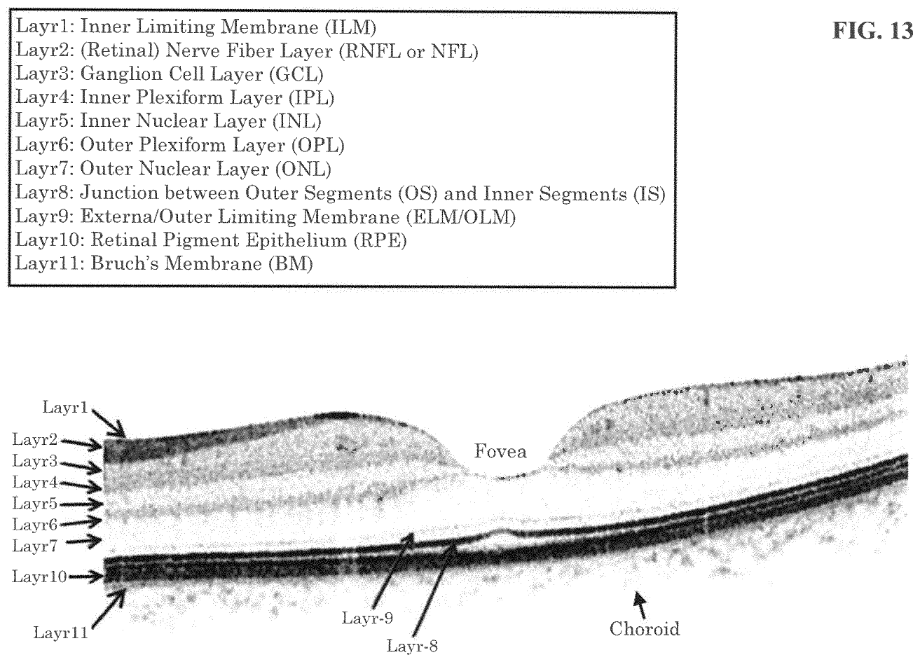

A variety of ways to create B-scans are known in the art including but not limited to: along the horizontal or x-direction, along the vertical or y-direction, along the diagonal of x and y, or in a circular or spiral pattern. B-scans may be in the x-z dimensions but may be any cross-sectional image that includes the z-dimension. An example OCT B-scan image of a normal retina of a human eye is illustrated in FIG. 13. An OCT B-scan of the retinal provides a view of the structure of retinal tissue. For illustration purposes, FIG. 13 identifies various canonical retinal layers and layer boundaries. The identified retinal boundary layers include (from top to bottom): the inner limiting membrane (ILM) Lyer1, the retinal nerve fiber layer (RNFL or NFL) Layr2, the ganglion cell layer (GCL) Layr3, the inner plexiform layer (IPL) Layr4, the inner nuclear layer (INL) Layr5, the outer plexiform layer (OPL) Layr6, the outer nuclear layer (ONL) Layr7, the junction between the outer segments (OS) and inner segments (IS) (indicated by reference character Layr8) of the photoreceptors, the external or outer limiting membrane (ELM or OLM) Layr9, the retinal pigment epithelium (RPE) Layr10, and the Bruch's membrane (BM) Layr11.

In OCT Angiography, or Functional OCT, analysis algorithms may be applied to OCT data collected at the same, or about the same, sample locations on a sample at different times (e.g., a cluster scan) to analyze motion or flow (see for example US Patent Publication Nos. 2005/0171438, 2012/0307014, 2010/0027857, 2012/0277579 and U.S. Pat. No. 6,549,801, which are herein incorporated in their entirety by reference). An OCT system may use any one of a number of OCT angiography processing algorithms (e.g., motion contrast algorithms) to identify blood flow. For example, motion contrast algorithms can be applied to the intensity information derived from the image data (intensity-based algorithm), the phase information from the image data (phase-based algorithm), or the complex image data (complex-based algorithm). An en face image is a 2D projection of 3D OCT data (e.g., by averaging the intensity of each individual A-scan, such that each A-scan defines a pixel in the 2D projection). Similarly, an en face vasculature image is an image displaying motion contrast signal in which the data dimension corresponding to depth (e.g., z-direction along an A-scan) is displayed as a single representative value (e.g., a pixel in a 2D projection image), typically by summing or integrating all or an isolated portion of the data (see for example U.S. Pat. No. 7,301,644 herein incorporated in its entirety by reference). OCT systems that provide an angiography imaging functionality may be termed OCT angiography (OCTA) systems.

FIG. 14 shows an example of an en face vasculature image. After processing the data to highlight motion contrast using any of the motion contrast techniques known in the art, a range of pixels corresponding to a tissue depth from the surface of internal limiting membrane (ILM) in retina, may be summed to generate the en face (e.g., frontal view) image of the vasculature. FIG. 15 shows an exemplary B-scan of a vasculature (OCTA) image. As illustrated, structural information may not be well-defined since blood flow may traverse multiple retinal layers making them less defined than in a structural OCT B-scan, as in FIG. 13. Still, OCTA provides a non-invasive technique for imaging the microvasculature of the retina and the choroid, which may be critical to diagnosing and/or monitoring various pathologies. For example, OCTA may identify diabetic retinopathy by identifying microaneurysms, neovascular complexes, and measuring foveal avascular zone and nonperfused areas. OCTA has been in good agreement with fluorescein angiography (FA), a more traditional, but more evasive, technique requiring the injection of a dye to observe vascular flow in the retina. Also, in dry age-related macular degeneration, OCTA has been used to monitor a general decrease in choriocapillaris flow. Similarly in wet age-related macular degeneration, OCTA can provides a qualitative and quantitative analysis of choroidal neovascular membranes. OCTA has also been used to study vascular occlusions, e.g., evaluation of nonperfused areas and the integrity of superficial and deep plexus.

Neural Networks

The present invention may use a neural network (NN) machine learning (ML) model. For the sake of completeness, a general discussion of neural networks is provided herein. The present invention may use any, singularly or in combination, of the below described neural network architecture(s). A neural network, or neural net, is a (nodal) network of interconnected neurons, where each neuron represents a node in the network. Groups of neurons may be arranged in layers, with the outputs of one layer feeding forward to a next layer in a multilayer perceptron (MLP) arrangement. MLP may be understood to be a feedforward neural network model that maps a set of input data onto a set of output data.

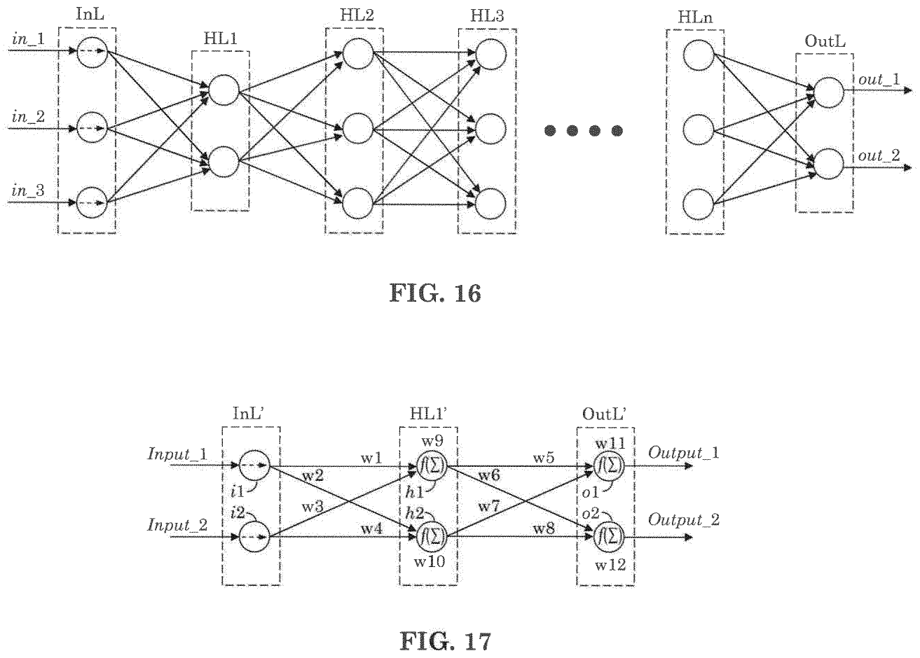

FIG. 16 illustrates an example of a multilayer perceptron (MLP) neural network. Its structure may include multiple hidden (e.g., internal) layers HL1 to HLn that map an input layer InL (that receives a set of inputs (or vector input) in_1 to in_3) to an output layer OutL that produces a set of outputs (or vector output), e.g., out_1 and out_2. Each layer may have any number of nodes, which are herein illustratively shown as circles within each layer. In the present example, the first hidden layer HL1 has two nodes, while hidden layers HL2, HL3, and HLn each have three nodes. Generally, the deeper the MLP (e.g., the greater the number of hidden layers in the MLP), the greater its capacity to learn. The input layer InL receives a vector input (illustratively shown as a three-dimensional vector consisting of in_1, in_2 and in_3), and may apply the received vector input to the first hidden layer HL1 in the sequence of hidden layers. An output layer OutL receives the output from the last hidden layer, e.g., HLn, in the multilayer model, processes its inputs, and produces a vector output result (illustratively shown as a two-dimensional vector consisting of out_1 and out_2).

Typically, each neuron (or node) produces a single output fed forward to neurons in the layer immediately following it. But each neuron in a hidden layer may receive multiple inputs, either from the input layer or from the outputs of neurons in an immediately preceding hidden layer. Each node may apply a function to its inputs to produce an output for that node. Nodes in hidden layers (e.g., learning layers) may apply the same function to their respective input(s) to produce their respective output(s). Some nodes, however, such as the nodes in the input layer InL receive only one input and may be passive, meaning they simply relay the values of their single input to their output(s), e.g., they provide a copy of their input to their output(s), as illustratively shown by dotted arrows within the nodes of input layer InL.

For illustration purposes, FIG. 17 shows a simplified neural network consisting of an input layer InL′, a hidden layer HL1′, and an output layer OutL′. Input layer InL′ is shown having two input nodes i1 and i2 that respectively receive inputs Input_1 and Input_2 (e.g. the input nodes of layer InL′ receive an input vector of two dimensions). The input layer InL′ feeds forward to one hidden layer HL1′ having two nodes h1 and h2, which feeds forward to an output layer OutL′ of two nodes o1 and o2. Interconnections, or links, between neurons (illustrative shown as solid arrows) have weights w1 to w8. Typically, except for the input layer, a node (neuron) may receive as input the outputs of nodes in its immediately preceding layer. Each node may calculate its output by multiplying each of its inputs by each input's corresponding interconnection weight, summing the products of it inputs, adding (or multiplying by) a constant defined by another weight or bias that may be associated with that particular node (e.g., node weights w9, w10, w11, w12 respectively corresponding to nodes h1, h2, o1, and o2), and then applying a non-linear function or logarithmic function to the result. The non-linear function may be termed an activation function or transfer function. Multiple activation functions are known the art, and choice of a specific activation function is not critical to the present discussion. It is noted, however, that operation of the ML model, or behavior of the neural net, depends upon weight values, which may be learned so the neural network provides a desired output for a input.

The neural net learns (e.g., is trained to determine) appropriate weight values to achieve a desired output for a input during a training, or learning, stage. Before the neural net is trained, each weight may be individually assigned an initial (e.g., random and optionally non-zero) value, e.g., a random-number seed. Various methods of assigning initial weights are known in the art. The weights are then trained (optimized) so that for a training vector input, the neural network produces an output close to a desired (predetermined) training vector output. For example, the weights may be incrementally adjusted in thousands of iterative cycles by a technique termed back-propagation. In each cycle of back-propagation, a training input (e.g., vector input or training input image/sample) is fed forward through the neural network to determine its actual output (e.g., vector output). An error for each output neuron, or output node, is then calculated based on the actual neuron output and a target training output for that neuron (e.g., a training output image/sample corresponding to the present training input image/sample). One then propagates back through the neural network (in a direction from the output layer back to the input layer) updating the weights based on how much effect each weight has on the overall error so the output of the neural network moves closer to the desired training output. This cycle is then repeated until the actual output of the neural network is within an acceptable error range of the desired training output for the training input. As it would be understood, each training input may require many back-propagation iterations before achieving a desired error range. Typically, an epoch refers to one back-propagation iteration (e.g., one forward pass and one backward pass) of all the training samples, such that training a neural network may require many epochs. Generally, the larger the training set, the better the performance of the trained ML model, so various data augmentation methods may increase the size of the training set. For example, when the training set includes pairs of corresponding training input images and training output images, the training images may be divided into multiple corresponding image segments (or patches). Corresponding patches from a training input image and training output image may be paired to define multiple training patch pairs from one input/output image pair, which enlarges the training set. Training on large training sets, however, places high demands on computing resources, e.g., memory and data processing resources. Computing demands may be reduced by dividing a large training set into multiple mini-batches, where the mini-batch size defines the number of training samples in one forward/backward pass. Here, and one epoch may include multiple mini-batches. Another issue is the possibility of a NN overfitting a training set such that its capacity to generalize from a specific input to a different input is reduced. Issues of overfitting may be mitigated by creating an ensemble of neural networks or by randomly dropping out nodes within a neural network during training, which effectively removes the dropped nodes from the neural network. Various dropout regulation methods, such as inverse dropout, are known in the art.

It is noted that the operation of a trained NN machine model is not a straight-forward algorithm of operational/analyzing steps. When a trained NN machine model receives an input, the input is not analyzed in the traditional sense. Rather, irrespective of the subject or nature of the input (e.g., a vector defining a live image/scan or a vector defining some other entity, such as a demographic description or a record of activity) the input will be subjected to the same predefined architectural construct of the trained neural network (e.g., the same nodal/layer arrangement, trained weight and bias values, predefined convolution/deconvolution operations, activation functions, pooling operations, etc.), and it may not be clear how the trained network's architectural construct produces its output. The values of the trained weights and biases are not deterministic and depend upon many factors, such as the time the neural network is given for training (e.g., the number of epochs in training), the random starting values of the weights before training starts, the computer architecture of the machine on which the NN is trained, choice of training samples, distribution of the training samples among multiple mini-batches, choice of activation function(s), choice of error function(s) that modify the weights, and even if training is interrupted on one machine (e.g., having a first computer architecture) and completed on another machine (e.g., having a different computer architecture). The reasons a trained ML model reaches certain outputs is not clear, and much research is ongoing to determine the factors on which a ML model bases its outputs. So the processing of a neural network on live data cannot be reduced to a simple algorithm of steps. Rather, its operation depends upon its training architecture, training sample sets, training sequence, and various circumstances in the training of the ML model.

Construction of a NN machine learning model may include a learning (or training) stage and a classification (or operational) stage. In the learning stage, the neural network may be trained for a specific purpose and may be provided with a set of training examples, including training (sample) inputs and training (sample) outputs, and optionally including a set of validation examples to test the progress of the training. During this learning process, various weights associated with nodes and node-interconnections in the neural network are incrementally adjusted to reduce an error between an actual output of the neural network and the desired training output. In this manner, a multi-layer feed-forward neural network (such as discussed above) may be made capable of approximating any measurable function to any desired accuracy. The result of the learning stage is a (neural network) machine learning (ML) model that has been learned (e.g., trained). In the operational stage, a set of test inputs (or live inputs) may be submitted to the learned (trained) ML model, which may apply what it has learned to produce an output prediction based on the test inputs.

Like the regular neural networks of FIGS. 16 and 17, convolutional neural networks (CNN) are also made up of neurons that have learnable weights and biases. Each neuron receives inputs, performs an operation (e.g., dot product), and is optionally followed by a non-linearity. The CNN, however, may receive raw image pixels at one end (e.g., the input end) and provide classification (or class) scores at the other end (e.g., the output end). Because CNNs expect an image as input, they are optimized for working with volumes (e.g., pixel height and width of an image, plus the depth of the image, e.g., color depth such as an RGB depth defined of three colors: red, green, and blue). For example, the layers of a CNN may be optimized for neurons arranged in 3 dimensions. The neurons in a CNN layer may also be connected to a small region of the layer before it, instead of all of the neurons in a fully-connected NN. The final output layer of a CNN may reduce a full image into a single vector (classification) arranged along the depth dimension.

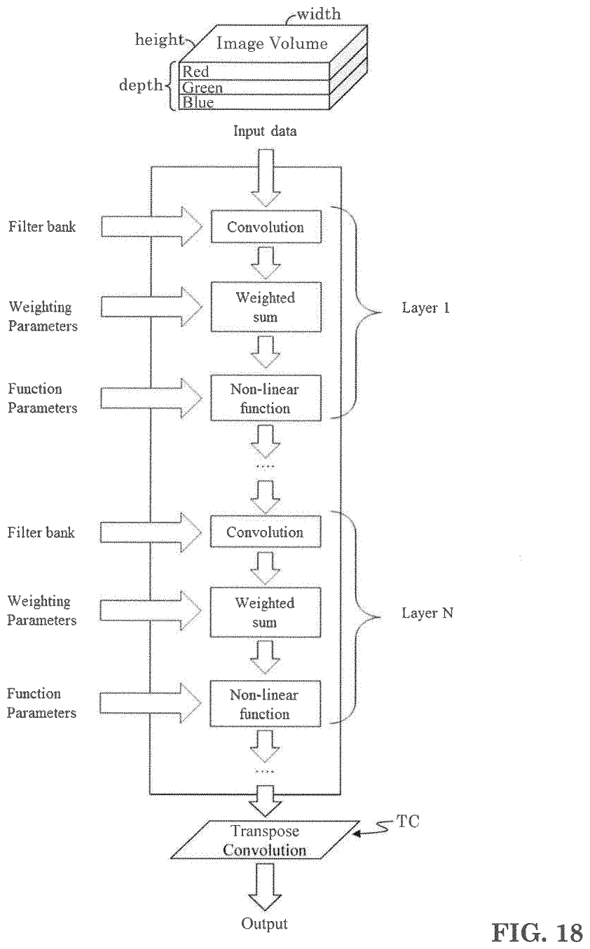

FIG. 18 provides an example convolutional neural network architecture. A convolutional neural network may be defined as a sequence of two or more layers (e.g., Layer 1 to Layer N), where a layer may include a (image) convolution step, a weighted sum (of results) step, and a non-linear function step. The convolution may be performed on its input data by applying a filter (or kernel), e.g., on a moving window across the input data, to produce a feature map. Each layer and component of a layer may have different pre-determined filters (from a filter bank), weights (or weighting parameters), and/or function parameters. In the present example, the input data is an image, which may be raw pixel values of the image, of a pixel height and width. In the present example, the input image is illustrated as having a depth of three color channels RGB (Red, Green, and Blue). Optionally, the input image may undergo various preprocessing, and the preprocessing results may be input in place of, or in addition to, the raw input image. Some examples of image preprocessing may include: retina blood vessel map segmentation, color space conversion, adaptive histogram equalization, connected components generation, etc. Within a layer, a dot product may be computed between the weights and a small region they are connected to in the input volume. Many ways of configuring a CNN are known in the art, but as an example, a layer may be configured to apply an elementwise activation function, such as max (0,x) thresholding at zero. A pooling function may be performed (e.g., along the x-y directions) to down-sample a volume. A fully-connected layer may determine the classification output and produce a one-dimensional output vector, which has been found useful for image recognition and classification. However, for image segmentation, the CNN would need to classify each pixel. Since each CNN layers reduces the resolution of the input image, another stage is needed to up-sample the image back to its original resolution. This may be achieved by application of a transpose convolution (or deconvolution) stage TC, which rarely uses any predefine interpolation method, and instead has learnable parameters.

Convolutional Neural Networks have been successfully applied to many computer vision problems. Training a CNN generally requires a large training dataset. The U-Net architecture is based on CNNs and can generally be trained on a smaller training dataset than conventional CNNs.

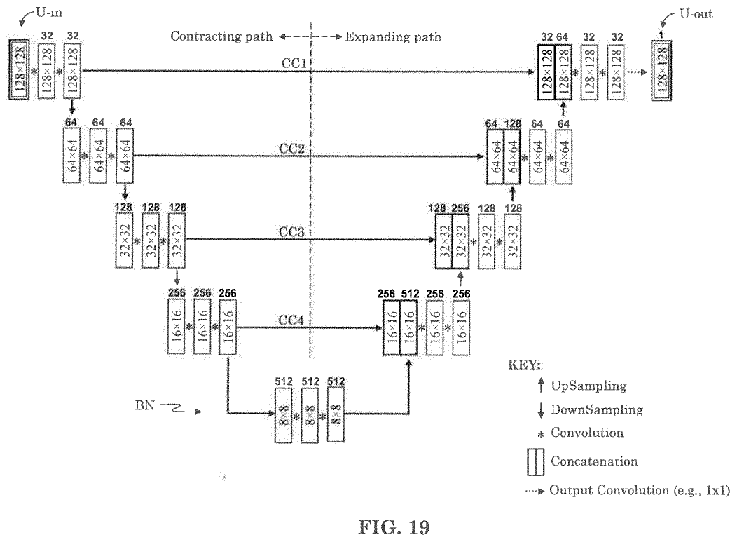

FIG. 19 illustrates an example U-Net architecture. The present exemplary U-Net includes an input module (or input layer or stage) that receives an input U-in (e.g., input image or image patch) of any size. For illustration purposes, the image size at any stage, or layer, is indicated within a box that represents the image, e.g., the input module encloses number “128×128” to indicate that input image U-in comprises 128 by 128 pixels. The input image may be a fundus image, an OCT/OCTA en face, B-scan image, etc. It is to be understood, however, that the input may be of any size or dimension. For example, the input image may be an RGB color image, monochrome image, volume image, etc. The input image undergoes a series of processing layers, each of which is illustrated with exemplary sizes, but these sizes are illustration purposes only and would depend, for example, upon the size of the image, convolution filter, and/or pooling stages. The present architecture consists of a contracting path (herein illustratively comprised of four encoding modules) followed by an expanding path (herein illustratively comprised of four decoding modules), and copy-and-crop links (e.g., CC1 to CC4) between corresponding modules/stages that copy the output of one encoding module in the contracting path and concatenates it to (e.g., appends it to the back of) the up-converted input of a correspond decoding module in the expanding path. This results in a characteristic U-shape, from which the architecture draws its name. Optionally, such as for computational considerations, a “bottleneck” module/stage (BN) may be positioned between the contracting path and the expanding path. The bottleneck BN may consist of two convolutional layers (with batch normalization and optional dropout).

The contracting path is similar to an encoder, and generally captures context (or feature) information by feature maps. In the present example, each encoding module in the contracting path may include two or more convolutional layers, illustratively indicated by an asterisk symbol “*”, and which may be followed by a max pooling layer (e.g., DownSampling layer). For example, input image U-in is illustratively shown to undergo two convolution layers, each with 32 feature maps. As it would be understood, each convolution kernel produces a feature map (e.g., the output from a convolution operation with a kernel is an image typically termed a “feature map”). For example, input U-in undergoes a first convolution that applies 32 convolution kernels (not shown) to produce an output consisting of 32 respective feature maps. However, as it is known in the art, the number of feature maps produced by a convolution operation may be adjusted (up or down). For example, the number of feature maps may be reduced by averaging groups of feature maps, dropping some feature maps, or other known method of feature map reduction. In the present example, this first convolution is followed by a second convolution whose output is limited to 32 feature maps. Another way to envision feature maps may be to think of the output of a convolution layer as a 3D image whose 2D dimension is given by the listed X-Y planar pixel dimension (e.g., 128×128 pixels), and whose depth is given by the number of feature maps (e.g., 32 planar images deep). Following this analogy, the output of the second convolution (e.g., the output of the first encoding module in the contracting path) may be described as a 128×128×32 image. The output from the second convolution then undergoes a pooling operation, which reduces the 2D dimension of each feature map (e.g., the X and Y dimensions may each be reduced by half). The pooling operation may be embodied within the DownSampling operation, as indicated by a downward arrow. Several pooling methods, such as max pooling, are known in the art and the specific pooling method is not critical to the present invention. The number of feature maps may double at each pooling, starting with 32 feature maps in the first encoding module (or block), 64 in the second encoding module, and so on. The contracting path thus forms a convolutional network consisting of multiple encoding modules (or stages or blocks). As is typical of convolutional networks, each encoding module may provide at least one convolution stage followed by an activation function (e.g., a rectified linear unit (ReLU) or sigmoid layer), not shown, and a max pooling operation. Generally, an activation function introduces non-linearity into a layer (e.g., to help avoid overfitting issues), receives the results of a layer, and determines whether to “activate” the output (e.g., determines whether the value of a node meets predefined criteria to have an output forwarded to a next layer/node). The contracting path generally reduces spatial information while increasing feature information.

The expanding path is similar to a decoder, and may provide localization and spatial information for the results of the contracting path, despite the down sampling and any max-pooling performed in the contracting stage. The expanding path includes multiple decoding modules, where each decoding module concatenates its current up-converted input with the output of a corresponding encoding module. In this manner, feature and spatial information are combined in the expanding path through a sequence of up-convolutions (e.g., UpSampling or transpose convolutions or deconvolutions) and concatenations with high-resolution features from the contracting path (e.g., via CC1 to CC4). Thus, the output of a deconvolution layer is concatenated with the corresponding (optionally cropped) feature map from the contracting path, followed by two convolutional layers and activation function (with optional batch normalization).

The output from the last expanding module in the expanding path may be fed to another processing/training block or layer, such as a classifier block, that may be trained along with the U-Net architecture. Alternatively, or in addition, the output of the last upsampling block (at the end of the expanding path) may be submitted to another convolution (e.g., an output convolution) operation, as indicated by a dotted arrow, before producing its output U-out. The kernel size of output convolution may be selected to reduce the dimensions of the last upsampling block to a desired size. For example, the neural network may have multiple features per pixels right before reaching the output convolution, which may provide a 1×1 convolution operation to combine these multiple features into a single output value per pixel, on a pixel-by-pixel level.

Computing Device/System

FIG. 20 illustrates an example computer system (or computing device or computer device). In some embodiments, one or more computer systems may provide the functionality described or illustrated herein and/or perform one or more steps of one or more methods described or illustrated herein. The computer system may take any suitable physical form. For example, the computer system may be an embedded computer system, a system-on-chip (SOC), a single-board computer system (SBC) (such as a computer-on-module (COM) or system-on-module (SOM)), a desktop computer system, a laptop or notebook computer system, a mesh of computer systems, a mobile telephone, a personal digital assistant (PDA), a server, a tablet computer system, an augmented/virtual reality device, or a combination of two or more of these. Where appropriate, the computer system may live in a cloud, which may include one or more cloud parts in one or more networks.

In some embodiments, the computer system may include a processor Cpnt1, memory Cpnt2, storage Cpnt3, an input/output (I/O) interface Cpnt4, a communication interface Cpnt5, and a bus Cpnt6. The computer system may optionally also include a display Cpnt7, such as a computer monitor or screen.

Processor Cpnt1 includes hardware for executing instructions, such as those making up a computer program. For example, processor Cpnt1 may be a central processing unit (CPU) or a general-purpose computing on graphics processing unit (GPGPU). Processor Cpnt1 may retrieve (or fetch) the instructions from an internal register, an internal cache, memory Cpnt2, or storage Cpnt3, decode and execute the instructions, and write one or more results to an internal register, an internal cache, memory Cpnt2, or storage Cpnt3. In particular embodiments, processor Cpnt1 may include one or more internal caches for data, instructions, or addresses. Processor Cpnt1 may include one or more instruction caches, one or more data caches, such as to hold data tables. Instructions in the instruction caches may be copies of instructions in memory Cpnt2 or storage Cpnt3, and the instruction caches may speed up retrieval of those instructions by processor Cpnt1. Processor Cpnt1 may include any suitable number of internal registers, and may include one or more arithmetic logic units (ALUs). Processor Cpnt1 may be a multi-core processor; or include one or more processors Cpnt1. Although this disclosure describes and illustrates a particular processor, this disclosure contemplates any suitable processor.

Memory Cpnt2 may include main memory for storing instructions for processor Cpnt1 to execute or to hold interim data during processing. For example, the computer system may load instructions or data (e.g., data tables) from storage Cpnt3 or from another source (such as another computer system) to memory Cpnt2. Processor Cpnt1 may load the instructions and data from memory Cpnt2 to one or more internal register or internal cache. To execute the instructions, processor Cpnt1 may retrieve and decode the instructions from the internal register or internal cache. During or after execution of the instructions, processor Cpnt1 may write one or more results (which may be intermediate or final results) to the internal register, internal cache, memory Cpnt2 or storage Cpnt3. Bus Cpnt6 may include one or more memory buses (which may each include an address bus and a data bus) and may couple processor Cpnt1 to memory Cpnt2 and/or storage Cpnt3. Optionally, one or more memory management unit (MMU) help with data transfers between processor Cpnt1 and memory Cpnt2. Memory Cpnt2 (which may be fast, volatile memory) may include random access memory (RAM), such as dynamic RAM (DRAM) or static RAM (SRAM). Storage Cpnt3 may include long-term or mass storage for data or instructions. Storage Cpnt3 may be internal or external to the computer system, and include one or more of a disk drive (e.g., hard-disk drive, HDD, or solid-state drive, SSD), flash memory, ROM, EPROM, optical disc, magneto-optical disc, magnetic tape, Universal Serial Bus (USB)-accessible drive, or other type of non-volatile memory.

I/O interface Cpnt4 may be software, hardware, or a combination of both, and include one or more interfaces (e.g., serial or parallel communication ports) for communication with I/O devices, which may enable communication with a person (e.g., user). For example, I/O devices may include a keyboard, keypad, microphone, monitor, mouse, printer, scanner, speaker, still camera, stylus, tablet, touch screen, trackball, video camera, another suitable I/O device, or a combination of two or more of these.

Communication interface Cpnt5 may provide network interfaces for communication with other systems or networks. Communication interface Cpnt5 may include a Bluetooth interface or other type of packet-based communication. For example, communication interface Cpnt5 may include a network interface controller (NIC) and/or a wireless NIC or a wireless adapter for communicating with a wireless network. Communication interface Cpnt5 may provide communication with a WI-FI network, an ad hoc network, a personal area network (PAN), a wireless PAN (e.g., a Bluetooth WPAN), a local area network (LAN), a wide area network (WAN), a metropolitan area network (MAN), a cellular telephone network (such as a Global System for Mobile Communications (GSM) network), the Internet, or a combination of two or more of these.

Bus Cpnt6 may provide a communication link between the above-mentioned components of the computing system. For example, bus Cpnt6 may include an Accelerated Graphics Port (AGP) or other graphics bus, an Enhanced Industry Standard Architecture (EISA) bus, a front-side bus (FSB), a HyperTransport (HT) interconnect, an Industry Standard Architecture (ISA) bus, an InfiniBand bus, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or other suitable bus or a combination of two or more of these.

In various exemplary embodiments, a method for segmenting one or more target retinal layers from an optical coherence tomography (OCT) volume scan of an eye is provided. The method includes acquiring, by an OCT system, the OCT volume scan which includes a plurality B-scans. Then submitting, by the OCT system, one or more B-scans to a deep learning machine model that is configured with a self-attention mechanism that enables differentially weighing priority levels of different regions of each B-scan based on a regions' relationship to the one or more target retinal layers by enhancing regions of each B-scan associated with the one or more target retinal layers and deemphasizing regions not associated with the one or more target retinal layers. The deep learning machine model is configured to maintain a data density of a width dimension of each B-scan, and to reduce the data density of the depth dimension of each B-scan based on the number of the one or more target retinal layers to be segmented. Each B-scan comprises a plurality of adjacent A-scans, and wherein the self-attention mechanism enhances one or more Layer-of-Interest (LOI) regions corresponding with the one or more target retinal layers within each A-scan based on topology information. The plurality of adjacent A-scans are processed in parallel.

In various exemplary embodiments, a method for segmenting one or more target retinal layers from an optical coherence tomography (OCT) scan of an eye is provided. The method includes acquiring, by an OCT system, the OCT scan, including at least one B-scan; submitting, by the OCT system, one or more of said at least one B-scan to a deep learning machine model based on a neural network trained with a training set which includes augmented training samples. The creation of the augmented training samples includes: collecting, by a processor, raw spectral data with high-resolution; constructing, by the processor, primary high-resolution OCT image data from the collected raw spectral data with high-resolution; defining, by the processor, ground truth layer segmentation label data from the primary high-resolution OCT image data; amending, by the processor, the raw spectral data and generating secondary OCT image data; and using, by the processor, the secondary OCT image data as an augmented training sample and the ground truth layer segmentation label data as part of a training output target sample in the training set of the neural network. The primary high-resolution OCT image data and the secondary OCT image data provide structural data. An acquired OCT scan is a volume scan comprising a plurality of B-scans. Amending the raw spectral data comprises degrading the raw spectral data, and amending the raw spectral data also comprises applying local wrapping and changes in reflectivity to simulate at least one pathology of a plurality of pathologies, or accessing sample noise data from a store of OCT noise scans and applying the sampled noise data to the raw spectral data. The ground truth layer segmentation label data is defined by submission of the primary high-resolution OCT image data to an automated Multi retinal Layer Segmentation utility.

Although this disclosure describes and illustrates a particular computer system having a particular number of particular components in a particular arrangement, this disclosure contemplates any suitable computer system having any suitable number of any suitable components in any suitable arrangement.

Herein, a computer-readable non-transitory storage medium or media may include one or more semiconductor-based or other integrated circuits (ICs) (such, as field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

While the invention has been described in conjunction with several specific embodiments, it is evident to those skilled in the art that many further alternatives, modifications, and variations will be apparent in light of the foregoing description. Thus, the invention described herein is intended to embrace all such alternatives, modifications, applications and variations as may fall within the spirit and scope of the appended claims.

What is claimed:

1. A method for segmenting one or more target retinal layers from an optical coherence tomography (OCT) volume scan of an eye, comprising:
acquiring, by an OCT system, the OCT volume scan which includes a plurality B-scans; and
submitting, by the OCT system, one or more B-scans to a deep learning machine model that is configured with a self-attention mechanism that enables differentially weighing priority levels of different regions of each B-scan based on a regions' relationship to the one or more target retinal layers by enhancing regions of each B-scan associated with the one or more target retinal layers and deemphasizing regions not associated with the one or more target retinal layers;
wherein the deep learning machine model is configured to maintain a data density of a width dimension of each B-scan, and to reduce the data density of the depth dimension of each B-scan based on the number of the one or more target retinal layers to be segmented.

2. The method of claim 1, wherein each B-scan comprises a plurality of adjacent A-scans, and wherein the self-attention mechanism enhances one or more Layer-of-Interest (LOI) regions corresponding with the one or more target retinal layers within each A-scan based on topology information.

3. The method of claim 2, wherein the plurality of adjacent A-scans are processed in parallel.

4. The method of claim 2, wherein L is a number of target retinal layers to be segmented, and wherein the deep learning machine model makes L×W number of predictions per B-scan, each L row of prediction is configured in a size 1×W that represents a Layer-of-Interest (LOI).

5. The method of claim 1, wherein each B-scan comprises a plurality of adjacent A-scans, and wherein the deep learning machine model is based on a neural network that comprises a first Linear Projection layer which converts a depth dimension of A-scans to at least a common and fixed depth dimension that is smaller than an original depth dimension.

6. The method of claim 5, wherein the depth dimension of each A-scan is reduced at least by an amount comprising a factor of 100.

7. The method of claim 5, wherein the neural network comprises a transformer encoder that receives input of converted A-scans.

8. The method of claim 7, wherein the transformer encoder comprises a plurality of transformer layers.

9. The method of claim 7, further comprising:
projecting, by the OCT system, an output of the transformer encoder to a prediction layer by a second Linear Projection layer, wherein the prediction layer provides segmentation information of the one or more target retinal layers to an output layer that outputs one or more predictions on a per A-scan basis in parallel.

10. The method of claim 1, further comprising:
processing, by the OCT system, outputs from the self-attention mechanism to produce one or more predictions associated with segmentation of the one or more target retinal layers and associated with confidence maps for each predicted segmentation of the one or more target retinal layers.

11. The method of claim 10, wherein each predicted segmentation of the one or more target retinal layers is configured in a form of 2×(w), wherein w is a width of a submitted B-scan.

12. The method of claim 1, wherein the one or more predictions associated with a per target retinal layer comprises a center prediction defined as a center, a heights prediction defined as heights, and a set of output boundaries comprising an output upper layer boundary ymax and a lower layer boundary ymin per segmented target retinal layer is defined as:
$$y min = center - \frac{1}{2} * {h}_{1} {e}^{{h}_{2} * heights}$$
$$y max = center + \frac{1}{2} * {h}_{1} {e}^{{h}_{2} * heights}$$
wherein h₁ and h₂ are hyperparameters defining a thickness prediction of at least one target retinal layer.

13. The method of claim 12, wherein h₁ and h₂ are determined experimentally.

14. A method for segmenting one or more target retinal layers from an optical coherence tomography (OCT) scan of an eye, comprising:
acquiring, by an OCT system, the OCT scan, including at least one B-scan;
submitting, by the OCT system, one or more of the at least one B-scan to a deep learning machine model based on a neural network trained with a training set which includes augmented training samples;
wherein creation of the augmented training samples includes:
collecting, by a processor operably coupled with the OCT system, raw spectral data with high-resolution;
constructing, by the processor, primary high-resolution OCT image data from the collected raw spectral data with high-resolution;
defining, by the processor, ground truth layer segmentation label data from the primary high-resolution OCT image data;
amending, by the processor, the raw spectral data and generating secondary OCT image data; and
using, by the processor, the secondary OCT image data as an augmented training sample and the ground truth layer segmentation label data as part of a training output target sample in the training set of the neural network.

15. The method of claim 14, wherein the primary high-resolution OCT image data and the secondary OCT image data provide structural data.

16. The method of claim 14, wherein an acquired OCT scan is a volume scan comprising a plurality of B-scans.

17. The method of claim 14, wherein amending the raw spectral data comprises degrading the raw spectral data.

18. The method of claim 14, wherein amending the raw spectral data comprises applying local wrapping and changes in reflectivity to simulate at least one pathology of a plurality of pathologies.

19. The method of claim 14, wherein amending the raw spectral data comprises accessing sample noise data from a store of OCT noise scans and applying the sampled noise data to the raw spectral data.

20. The method of claim 14, wherein the ground truth layer segmentation label data is defined by submission of the primary high-resolution OCT image data to an automated Multi retinal Layer Segmentation utility.
